(19) United States
(12) Patent Application Publication
(10) Pub. No.: US 2015/0222485 A1
(43) Pub. Date: Aug. 6, 2015

(54) DYNAMIC SERVER CONFIGURATION AND INITIALIZATION

(71) Applicant: Darren Key, Raleigh, NC (US)

(72) Inventor: Darren Key, Raleigh, NC (US)

(73) Assignee: SAS Institute Inc., Cary, NC (US)

(21) Appl. No.: 14/615,925

(22) Filed: Feb. 6, 2015

Related U.S. Application Data
(60) Provisional application No. 61/936,432, filed on Feb. 6, 2014.

(51) Int. Cl. H04L 12/24; H04L 29/08

(52) U.S. Cl. CPC H04L 41/0816; H04L 67/02

(57) ABSTRACT

A computer-program product causing a processor component to identify requisite configuration information for executing an application routine by the processor component, wherein the requisite configuration information enables the application routine to communicate with another computing device via a network during execution of the application routine; generate an API that specifies the requisite configuration information to a resource device via the network when the resource device accesses the API via the network; operate a network interface that couples the processor component to the network to make the API accessible to the resource device via the network to enable the resource device to provide the requisite configuration information; and relay the requisite configuration information following provision of the requisite configuration information by the resource device to the application routine for use during execution of the application routine and to a start component to trigger a start of execution of the application routine.

### CROSS-REFERENCE TO RELATED APPLICATIONS

This application claims the benefit of priority under 35 U.S.C. §119(e) to U.S. Provisional Application Ser. No. 61/936,432 entitled “AUTOMATIC DISCOVERY OF CONFIGURATION NEEDS AND GENERATION OF RESTFUL APIs” filed Feb. 6, 2014, the entirety of which is incorporated herein by reference.

### BACKGROUND

It has become commonplace to deploy combinations of computing devices to provide various server functions accessible by a network. One or more of such computing devices may further provide multiple virtual machine (VM) environments within to simulate the presence of an ever greater quantity of computing devices and/or operating systems. Such complex installations may be used to support the execution of multiple applications to provide a variety of server functions, and/or to improve performance and responsiveness of one or more server functions by executing multiple instances of the same application in parallel.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

A computer-program product may be tangibly embodied in a non-transitory machine-readable storage medium where the computer-program product may include instructions that may be operable to cause a processor component to perform operations including identify requisite configuration information for execution of an application routine by the processor component, wherein the requisite configuration information enables the application routine to communicate with another computing device via a network during execution of the application routine; generate an application programming interface (API) that specifies the requisite configuration information to a resource device via the network when the resource device accesses the API via the network; operate a network interface that couples the processor component to the network to make the API accessible to the resource device via the network to enable the resource device to provide the requisite configuration information; and relay the requisite configuration information following provision of the requisite configuration information by the resource device to the application routine for use during execution of the application routine and to a start component to trigger a start of execution of the application routine.

A computer-implemented method may include identifying requisite configuration information for execution of an application routine by a processor component, wherein the requisite configuration information enables the application routine to communicate with another computing device via a network during execution of the application routine; generating an application programming interface (API) that specifies the requisite configuration information to a resource device via the network when the resource device accesses the API via the network; operating a network interface coupling the processor component to the network to make the API accessible to the resource device via the network to enable the resource device to provide the requisite configuration information; and relaying the requisite configuration information following provision of the requisite configuration information by the resource device to the application routine for use during execution of the application routine and to a start component to trigger a start of execution of the application routine.

An apparatus may include a processor component; a network interface to couple the processor component to a network; a discovery component for execution by the processor component to identify requisite configuration information for execution of an application routine, wherein the requisite configuration information enables the application routine to communicate with another computing device via the network during execution of the application routine; an application program interface (API) generator for execution by the processor component to generate an API that specifies the requisite configuration information to the resource device via the network when the resource device accesses the API via the network, and to operate the network interface to make the API accessible to the resource device via the network to enable the resource device to provide the requisite configuration information; and an API monitor to monitor the interface for activity by the resource device to provide the requisite configuration information, and to relay the requisite configuration information following provision of the requisite configuration information by the resource device to the application routine for use during execution of the application routine and to a start component to trigger a start of execution of the application routine.

A computer-program product may be tangibly embodied in a non-transitory machine-readable storage medium where the computer-program product may include instructions that may be operable to cause a processor component to perform operations including transmit a request via a network to a control device for a list of application programming interface (API) calls of an application programming interface of the control device, wherein each API call is associated with a piece of requisite configuration information required to enable the control device to execute an application routine, and wherein the application routine requires provision of an online service by the processor component to the control device; select an API call from the list based on whether the piece of requisite configuration information associated with the API call is stored in a storage device coupled to the processor component; transmit the piece of requisite configuration information to the control device in a call to the selected API call; and provide the online service to the control device in response to a request from the application routine for the service. The requisite configuration information may include at least one of a network address at which the processor component is able to be contacted, an account ID to gain access to the online service, a password to gain access to the online service, or contact information to use in transmitting an indication of an error encountered in using the online service. The requisite configuration information may include at least one of a network address at which a virtual machine (VM) of the control device in which application routine is executed is accessible to the processor component, an account ID to be accepted by the VM to grant access to the VM from the network by the processor component, or a password to be accepted by the VM to grant access to the VM from the network by the processor component. The online service may include at least one of email, archival file storage or hardcopy printing.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other features will become apparent from the following detailed description when considered in conjunction with the drawings.

### BRIEF DESCRIPTION OF THE DRAWINGS

FIG. 1 illustrates an example embodiment of an online services system.

FIG. 2 illustrates an alternate example embodiment of an online services system.

FIG. 3 illustrates an example embodiment of provisioning an online services system with VM and application routines.

FIG. 4 illustrates an example embodiment of dynamically configuring VM environments and applications routine(s) executed therein.

FIG. 5 illustrates an example embodiment of identifying pieces of requisite configuration information to be provided by resource device(s).

FIG. 6 illustrates an example embodiment of providing an API to enable resource device(s) to provide pieces of requisite configuration information.

FIG. 7 illustrates an example embodiment of generating and distributing parameter catalogs that include received pieces of requisite configuration information.

FIG. 8 illustrates an alternate example embodiment of generating and distributing parameter catalogs that include received pieces of requisite configuration information.

FIG. 9 illustrates an example embodiment of a logic flow of a control device dynamically configuring and starting one or more application routines.

FIG. 10 illustrates an example embodiment of a logic flow of a node device cooperating with a control device to dynamically configure and start application routine(s).

FIG. 11 illustrates an example embodiment of a logic flow of a control device dynamically reconfiguring and optionally restarting one or more application routines.

FIG. 12 illustrates an example embodiment of a logic flow of a node device cooperating with a control device to restart one or more application routines.

FIG. 13 illustrates an example embodiment of a processing architecture.

### DETAILED DESCRIPTION

Combinations of multiple computing devices that are to operate together to provide various server functions can be difficult to configure, initialize, update and reinitialize correctly. Although various ones of the applications that are executed in such installations may have dependencies on each other and/or on resources provided by still other devices, there may be no provision within the applications and/or resources themselves to ease the work and complexity of configuring those applications and/or resources to cooperate in order to address those dependencies. Further, updates and/or upgrades to any one of the computing devices, applications and/or resources often require corresponding changes to one or more others of the computing devices, applications and/or resources.

Various embodiments described herein are generally directed to dynamically configuring and initializing virtual machine environments and application routines in computing devices deployed as servers. A combination of virtual machine (VM) environment, application software and dynamic configuration software may be installed on one or more computing devices operated as servers. Discovery components of the configuration software may perform various tests and/or searches for various pieces of configuration information concerning aspects of the computing device(s), the VMs to be provided within the computing device(s) and/or the application routine(s) to assemble a requisites database that includes indications of requisites for the execution of various routines, including indications of requisite configuration information. While some of the requisite configuration information may be derived from the tests and/or searches for pieces of configuration information, and may therefore be included in the requisites database, other pieces of requisite configuration information may need to be provided by one or more resource devices, and such a need may be indicated in the requisites database. A query component may generate and make available an application programming interface (API) on a network to enable one or more of the resource devices to provide such requisite configuration information, which may be used alongside indications of requisite configuration information already included in the requisites database to generate a configuration database of the configuration information. From the configuration database, a separate parameter catalog of configuration information may be generated for each of the computing devices that specifies various parameters for the operation of that computing device, one or more VMs that computing device, and/or one or more application routines executed within that computing device.

Virtual environment routines, one or more application routines, configuration software, parameter data and specifications of requisites for each may be packaged together into a single file (e.g., a single compressed file, such as a so-called “zip” file) and/or into a single storage medium (e.g., a optical disk or a solid state storage device, such as a “thumb drive”) for easier installation onto one or more computing devices deployed as servers. The particular combination of virtual environment routines and one or more application routines may be uniquely specified for each such package based on what combination of server functions are to be performed by the one or more computing devices onto which the package is to be installed. The need for customization of the virtual environment routines and/or the application routines, themselves, may be minimized or entirely eliminated based on a lack of need to include a configuration script tailored to the particular combination of virtual environment routines and/or application routines as a result of an ability of the configuration software to dynamically determine what routines are included in the package and to itself tailor the configuration of those routines based on what routines are so included.

Following installation of the package onto a computing device, and upon powering up or resetting of that computing device, a discovery component of the configuration software may perform various tests to determine various aspects of the hardware components of the computing device, such as processor component(s), available storage and/or available network interface(s). The discovery component may also search for and parse one or more files or data structures associated with the virtual environment routines and/or the application routines to obtain information concerning requisites for executing each of those routines. Those requisites may include requisite pieces of information that are needed to better enable execution of those routines and that may be directly provided by the one or more files or data structures and/or obtained through the performance of various tests. However, those requisites may also include requisite pieces of configuration information that need to be obtained from one or more resource devices to better enable executing those routines. Where multiple computing devices are to be used together such that the package may also be installed onto one or more additional computing devices, then similar testing and searches for configuration information may also occur within each of the one or more other computing devices.

In some embodiments, each application routine on each computing device may be required to be accompanied by, or otherwise include, a file or other data structure specifying the requisites of that application routine. In addition to ensuring that the requisites for each application routine are set forth in a discoverable manner, the presence of each such file or data structure may also serve as an indication of what application routines are actually installed on each computing device. It is in this way that the need to customize virtual environments and/or to create a customized configuration script for each possible combination of routines that may be installed on a given computing device may be eliminated. Stated differently, instead of a custom script file or other data structure having to be generated to indicate what routines are installed on a computing device, a search is conducted for files or data structures specifying execution requisites enables a determination to be made as to what routines are installed on that computing device.

The results of the tests and searches performed within the computing device, as well as within the one or more additional computing devices (if there are any), may be combined within the computing device to form a requisites database. An API generator of the configuration software may, for each requisite piece of configuration information to be obtained from a resource device, generate an API call by which a resource device may provide that requisite piece of configuration information. The various API calls so generated may, together, form an API that may be made accessible by the computing device on a network to one or more resource devices to use in providing at least a subset of the requisite pieces of information. Upon receiving at least a subset of the requisite pieces of information from one or more resource devices through the API, an API monitor may use those received pieces of configuration information alongside other requisite pieces of configuration information already included in the requisites database to generate a configuration database of configuration information.

A catalog generator may use the contents of the configuration database to generate one or more parameter catalogs of configuration information, one catalog for the computing device, and one or more additional catalogs for each of the one or more additional computing devices (if there are any). Where there are additional computing devices, the one or more additional catalogs may be transmitted by the computing device to corresponding one(s) of the additional computing device(s).

Among the pieces of configuration information in the configuration database that may be used in generating each parameter catalog may be indications of dependencies among one or more of the virtual environment routines and/or the application routines, as well as between one or more of those routines and one or more resource devices. Configuration information concerning such dependencies may result in an order of initialization of the various virtual environment routines and/or the application routines to ensure that, upon powering up and/or resetting one or more of the computing devices, routines associated with such dependencies are initialized in an order that accommodates those dependencies.

Following the starting of the virtual environment routines and the application routines in accordance with the parameter catalog(s), one or more of the tests and searches to obtain pieces of configuration information from which to form the requisites database, the communications with the one or more resource devices, the generation of the configuration database and the generation of the parameter catalogs may be repeated. Further, following an initial use of the API by one or more resource devices to provide some of the requisite pieces of configuration information, the one or more resource devices may subsequently use the same API again to change one or more of those requisite pieces of configuration information. Such changes by one or more of the resource devices may be incorporated into the configuration database and/or the parameter catalogs during a subsequent repetition of generating the configuration database and/or the parameter catalogs. In some embodiments, such repetition may take place at the end of a repeating interval of time.

With general reference to notations and nomenclature used herein, portions of the detailed description that follows may be presented in terms of program procedures executed on a computer or network of computers. These procedural descriptions and representations are used by those skilled in the art to most effectively convey the substance of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic or optical communications capable of being stored, transferred, combined, compared, and otherwise manipulated. It proves convenient at times, principally for reasons of common usage, to refer to what is communicated as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. These apparatus may be specially constructed for the required purpose or may include a general purpose computer. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives within the scope of the claims.

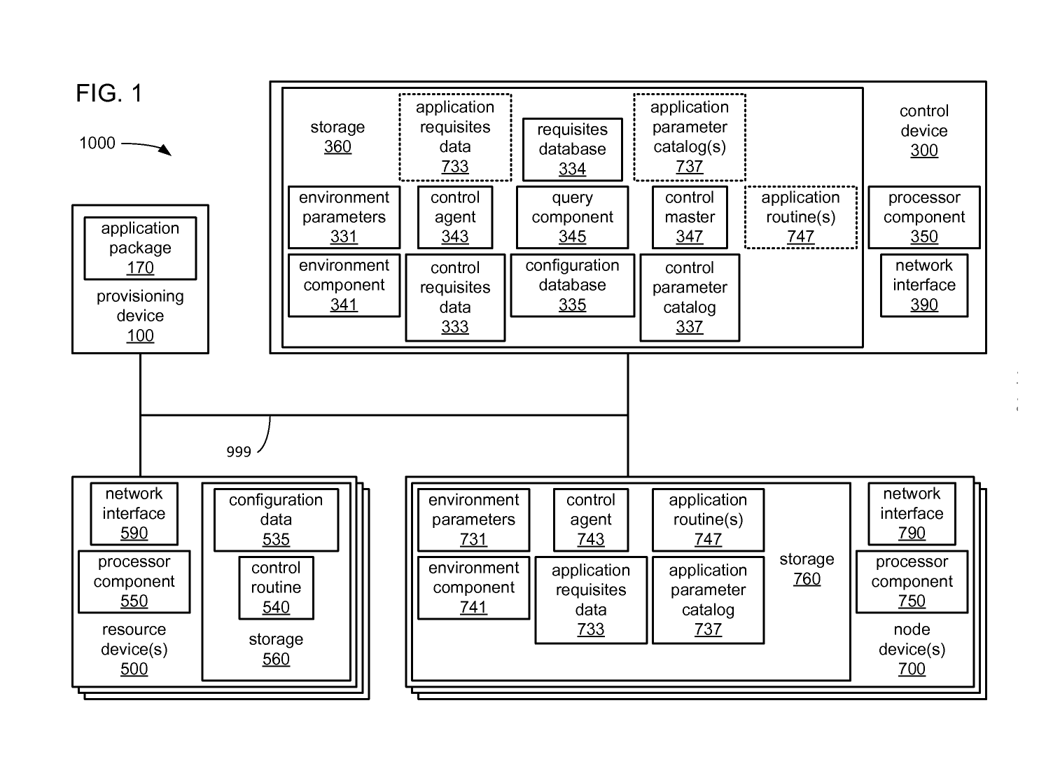

FIG. 1 illustrates a block diagram of an example embodiment of an online services system 1000 incorporating one or more of a provisioning device 100, a control device 300, one or more resource devices 500 and/or one or more node devices 700 that may cooperate to dynamically configure aspects of VM environments and/or application routines 747 that may be executed within those VM environments. In various embodiments, the control device 300 and the one or more node devices 700 may form a server farm, grid or other combination of computing devices that may be operated together to execute more than one application routine 747 and/or multiple instances of the same application routine 747 in parallel.

Each of the one or more application routines 747 may, when executed, provide any of a variety of online services, including and not limited to, online analytical processing (OLAP), statistical analysis of large quantities of data (sometimes referred to as data mining of “big data”), tracking of events in a manufacturing and/or distribution process, etc. During operation, the one or more application routines 747 executed within the control device 300 and/or the one or more node devices 700 may require access to services provided by one or more of the resource devices 500 via a network 999, including and not limited to, email, archival storage, hardcopy printing, etc.

The control device 300 and/or the one or more node devices 700 may be provided with a combination of software and configuration data for providing virtual machine environment(s) and/or executing the one or more application routines 747, and/or updates thereto, in an application package 170 via a network 999 from the provisioning device 100. Alternatively or additionally, the application package 170 may be conveyed from the provisioning device 100 to the control device 300 and/or the one or more node devices 700 via non-volatile removable storage media such as an optical disc or a solid state storage device.

At a time prior to execution of the one or more application routines 747, configuration software installed on the control device 300 and the one or more node devices 700 (if there are any) may identify and/or exchange configuration information concerning the requisites of each application routine 747, including pieces of configuration information required to be provided by one or more of the resource devices 500. Such configuration information may then be used by the control device 300 to obtain those requisite pieces of configuration information in communications with the one or more resource devices 500 in which the control device 300 generates an API used by the one or more resource devices 500 to provide those requisite pieces of configuration information. Following initialization of VMs and/or the application routines 747, such identification and/or exchanges of configuration information may be repeated on a recurring basis. It is during such repetitions that changes to requisite pieces of configuration information made by one or more of the resource devices 500 through the API may be also be exchanged.

Each of the computing devices 100, 300, 500 and 700 may be any of a variety of types of computing device, including without limitation, a desktop computer system, a data entry terminal, a laptop computer, a netbook computer, a tablet computer, a handheld personal data assistant, a smartphone, a digital camera, a body-worn computing device incorporated into clothing, a computing device integrated into a vehicle (e.g., a car, a bicycle, a wheelchair, etc.), a server, a cluster of servers, a server farm, etc. Embodiments are not limited in this context.

As depicted and as will be discussed, these computing devices 100, 300, 500 and/or 700 may exchange communications in support of the execution of one or more application routines 747 through the network 999. However, one or more of the computing devices 100, 300, 500 and/or 700 may exchange other data entirely unrelated to such execution with each other and/or with still other computing devices (not shown) via the network 999. In various embodiments, the network 999 may be a single network that may extend within a single building or other relatively limited area, a combination of connected networks that may extend a considerable distance, and/or may include the Internet. Thus, the network 999 may be based on any of a variety (or combination) of communications technologies by which communications may be effected, including without limitation, wired technologies employing electrically and/or optically conductive cabling, and wireless technologies employing infrared, radio frequency or other forms of wireless transmission.

In various embodiments, the control device 300 may incorporate one or more of a processor component 350, a storage 360 and an interface 390 to couple the control device 300 to the network 999. The storage 360 may store one or more of an environment component 341 accompanied by environment parameters 331, a control agent 343, a requisites database 334, a query component 345, a configuration database 335, a control master 347 accompanied by control requisites data 333, a control parameter catalog 337, one or more of the application routines 747 that may each be accompanied by its own application requisites data 733, and one or more application parameter catalogs 737.

Correspondingly, in various embodiments, each of the node devices 700 may incorporate one or more of a processor component 750, a storage 760 and an interface 790 to couple each of the node devices 700 to the network 999. The storage 760 may store one or more of an environment component 741 accompanied by environment parameters 731, a control agent 743, one or more of the application routines 747 that may each be accompanied by its own application requisites data 733, and one or more application parameter catalogs 737.

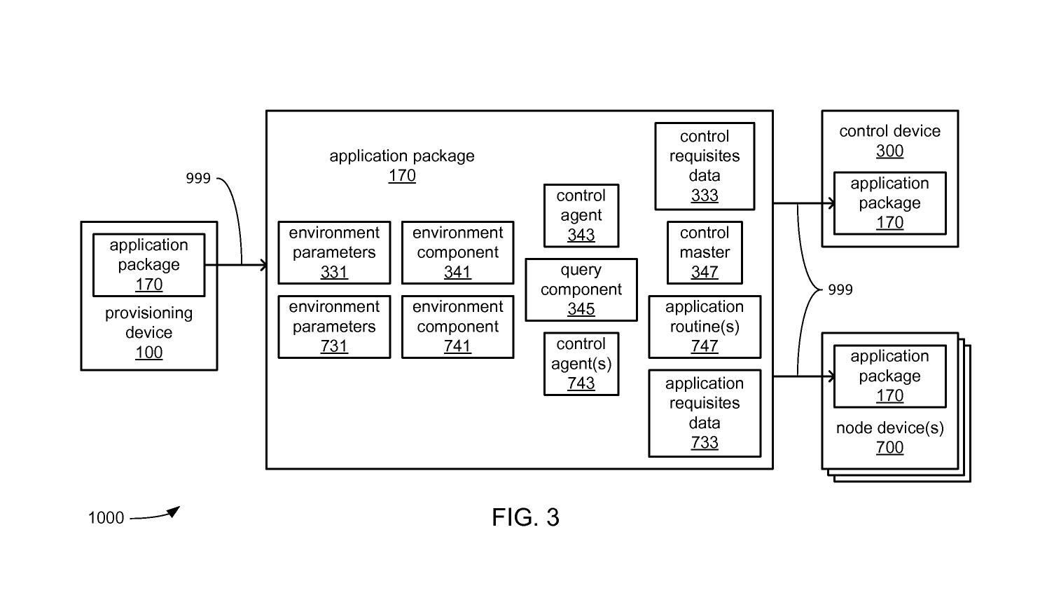

As previously discussed, the control device 300 and/or the one or more node devices 700 may be provided with VM environment routines and application routines via provision of the application package 170 from the provisioning device 100. FIG. 3 illustrates a block diagram of an example embodiment of the application package 170 and of such provisioning via the network 999. As depicted, the application package 170 may include one or more of the environment component 341 accompanied by the environment parameters 331, the environment component 741 accompanied by the environment parameters 731, the control master 347 accompanied by the control requisites data 333, the one or more application routines 747 accompanied by the application requisites data 733, the control agents 343 and 743, and the query component 345. Returning to FIG. 1, other data structures depicted as stored within the storage 360 of the control device 300 and the storage 760 of the one or more node devices 700 may be generated therein, as will shortly be explained in greater detail, and not supplied with the application package 170.

Within the control device 300, each of the environment component 341, the control agent 343, the query component 345, the control master 347, and at least one of the one or more application routines 747 may incorporate a sequence of instructions operative on the processor component 350 to implement logic to perform various functions when executed by the processor component 350. Correspondingly, within each of the one or more node devices 700, each of the environment component 741, the control agent 743, and at least one of the one or more application routines 747 may incorporate a sequence of instructions operative on the processor component 750 to implement logic to perform various functions when executed by the processor component 750. As familiar to those skilled in the art, in some embodiments, the sequence of instructions of one or more application routines 747 may need to be made operative on the processor component 350 and/or the processor component 750 through the provision of one or more VMs that enable execution of instructions meant for the instruction set of processor component by another processor component with a different instruction set.

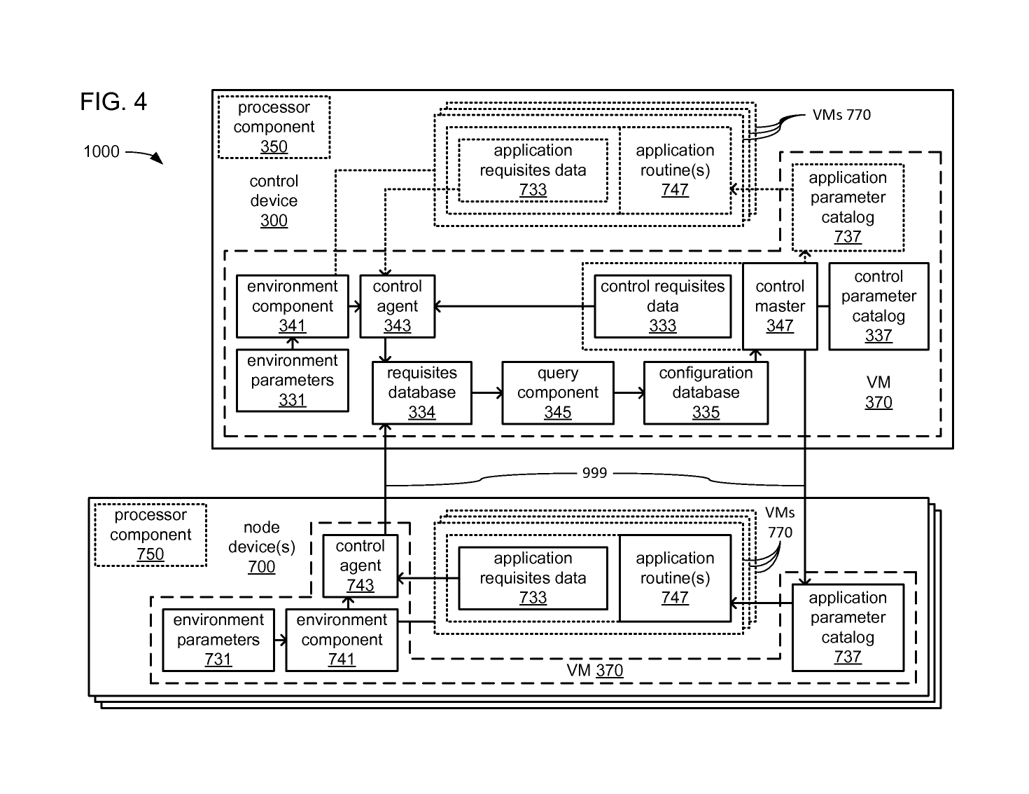

FIG. 4 illustrates a block diagram of an example embodiment of execution of one or more of the environment component 341 and/or 741, the control agent 343 and/or 743, the query component 345, the control master 347, and at least one of the one or more application routines 747 by the processor components 350 and 750. In embodiments in which one or more of the control agents 343 and/or 743, the query component 345, the control master 347, and one or more of the application routines 747 are to be executed within a VM, one or more of each of the depicted VMs 370 and 770 may be generated within the control device 300 and/or one or more of the node devices 700. More specifically, in executing the environment component 341, the processor component 350 of the control device 300 may be caused to instantiate a VM 370 in which VM management functions may be performed, and one or more VMs 770 in which an instance of an application routine 747 may be executed. In instantiating the VMs 370 and/or 770, the processor component 350 may be caused to retrieve various parameters for doing so from the environment parameters 331, including and not limited to, quantity of VMs to instantiate, amounts of addressable storage space to allocate to each VM, amount of processing resources to provide each VM, how to respond to error conditions occurring within a VM, etc. Having instantiated the VMs 370 and/or 770, further execution of the environment component 341 may cause the processor component 350 to perform various hypervisor functions in which the processor component 350 recurringly monitors the state of each of these VMs and responds to various errors and/or other conditions that may arise within each. More specifically, in executing the environment component 341 within the VM 370, the processor component 350 may employ the greater access privileges of the VM 370 to access portions of one or more of the VMs 770 in which one or more of the application routines 747 are executed to check various aspects of the execution of those application routines 747.

Similarly, in executing the environment component 741, the processor component 750 of each of the node devices 700 (if there are any) may be similarly caused to instantiate a corresponding VM 370 within that node device 700, and one or more of the VMs 770. In instantiating the VMs 370 and/or 770, the processor component 750 may be caused to retrieve various parameters for doing so from the environment parameters 731, including and not limited to, quantity of VMs to instantiate, amounts of addressable storage space to allocate to each VM, amount of processing resources to provide each VM, how to respond to error conditions occurring within a VM, etc. Having instantiated the VMs 370 and/or 770, further execution of the environment component 741 may cause the processor component 750 to perform various hypervisor functions in which the processor component 750 recurringly monitors the state of each of these VMs and responds to various errors and/or other conditions that may arise within each.

However, the hypervisor functions performed by the processor component 350 in executing the environment component 341 within the VM 370 of the control device 300 may be more extensive than those performed by the processor component 750 in executing the environment component 741 within the corresponding VM 370 of each of the node devices 700. More specifically, the processor component 350 may be caused to oversee the hypervisor functions performed by the processor component 750 within each of the one or more node devices 700. Thus, the parameters indicated within the environment parameters 331 and employed by the processor component 350 may differ from those indicated within the environment parameters 731 and applied by the processor component 750. In some embodiments, the environment components 341 and/or 741 may, for example, each be software routines implementing hypervisor and related functions from VMware® of Palo Alto, Calif. However, it is to be understood that what is described and claimed herein does not require and is not otherwise limited to the use of this particular software or any other particular software.

Following instantiation of the VMs 370 and/or 770, the processor components 350 and 750 may be further caused by the environment components 341 and 741 to begin execution of the control agents 343 and 743, respectively. In executing the control agent 343, the processor component 350 may perform a search within the control device 300 for the control requisites data 333 and for any instance of the application requisites data 733. Similarly, within each one of the one or more node devices 700, in executing the control agent 743, the processor component 750 of that one of the one or more node devices 700 may similarly perform a search within the that one of the node devices 700 for any instance of the application requisites data 733.

As previously discussed, each instance of any of the application routines 747 may be required to be accompanied by an instance of the application requisites data. Therefore, each instance of the application requisites data 733 that is found within the control device 300 and/or within one or more of the node devices 700 may, by the simple fact of having been found, serve as an indication of an instance of an application routine 747 having been installed therein. Thus, the performance of searches for the control requisites data 333 and/or any instances of the application requisites data 733 may provide an indication to the control agents 343 and/or 743 of what routines (e.g., the control master 347 and/or any instance of an application routine 740) are installed within and are to be executed within the control device 300 and/or each one of the one or more node devices 700. Indeed, such searches may provide an indication to the control agents 343 and/or 743 of what routines are installed within each VM 370 and/or 770 based on which VMs 370 and/or 770 the control requisites data 333 and/or each instance of the application requisites data 733 are found within.

As depicted, there is a single control agent 343 or 743 within each VM 370 such that there is one control agent 343 within the control device 300 and one instance of the control agent 743 within each of the node devices 700. However, it should be understood that this is one example allocation of control agents among the computing devices 300 and 700 in which there may be one or more VMs instantiated. In other embodiments, the allocation of control agents may be such that there is a separate control agent within each VM 370 and 770 such that there may be more than one control agent within each of the computing devices 300 and 700. Specifically, in such other embodiments, each VM 770 may have its own instance of the control agent 743. Again, however, still other embodiments are possible in which no VM environments are used, at all. In such other embodiments, there may again be only one control agent 343 within the control device 300 and again only one instance of the control agent 743 within each of the node devices 700.

Upon finding the control requisites data 333 and any instances of the application requisites data 733 within the control device 300, the control agent 343 may retrieve indications of requisites for the execution of the control master 347 from the control requisites data 333. The control agent 343 may also retrieve indications of requisites for the execution of one or more instances of one or more of the application routines 747 that are to be executed within the control device 300 from those instances of the application requisites data 733 found therein. Correspondingly, within each one of the node devices 700, upon finding any instances of the application requisites data 733 therein, the control agent 743 may retrieve indications of requisites for the execution of one or more instances of one or more application routines 747 that are to be executed within that one of the node devices 700 from those instances of the application requisites data 733 found therein. In some embodiments, the control agents 343 and/or 743 may each be an agent routine of, for example, the Puppet Enterprise™ software offered by Puppet Labs, Inc. of Portland, Oreg. However, it is to be understood that what is described and claimed herein does not require and is not otherwise limited to the use of this particular software or any other particular software.

In some embodiments (and as depicted with dotted lines), the control requisites data 333 may be embedded within or otherwise combined with the instructions of the control master 347, and similarly, the application requisite data 733 for each of the one or more application routines 747 may be embedded within or otherwise combined with the instructions of its corresponding one of the application routines 747. This may be deemed desirable as an approach to ensuring that indications of the requisites for execution of the control master 347 and/or of each of the one or more application routines 747 are always conveyed with those routines, instead of becoming separated therefrom in storage. However, in other embodiments, the control requisites data 333 and/or the application requisites data 733 for each of the one or more application routines 747 may be implemented as a separate data file or other data structure within which the various execution requisites may be indicated in any of a variety of ways. By way of example, the various indications of requisites within the control requisites data 333 and/or each such instance of the application requisites data 733 may be expressed in, for example, YAML™ (initials for either Yet Another Markup Language or YAML Ain't Markup Language) promulgated by three individual programmers, Oren Ben-Kiki, Clark Evans and Ingy dot Net. However, it is to be understood that what is described and claimed herein does not require and is not otherwise limited to the use of this particular language or any other particular language.

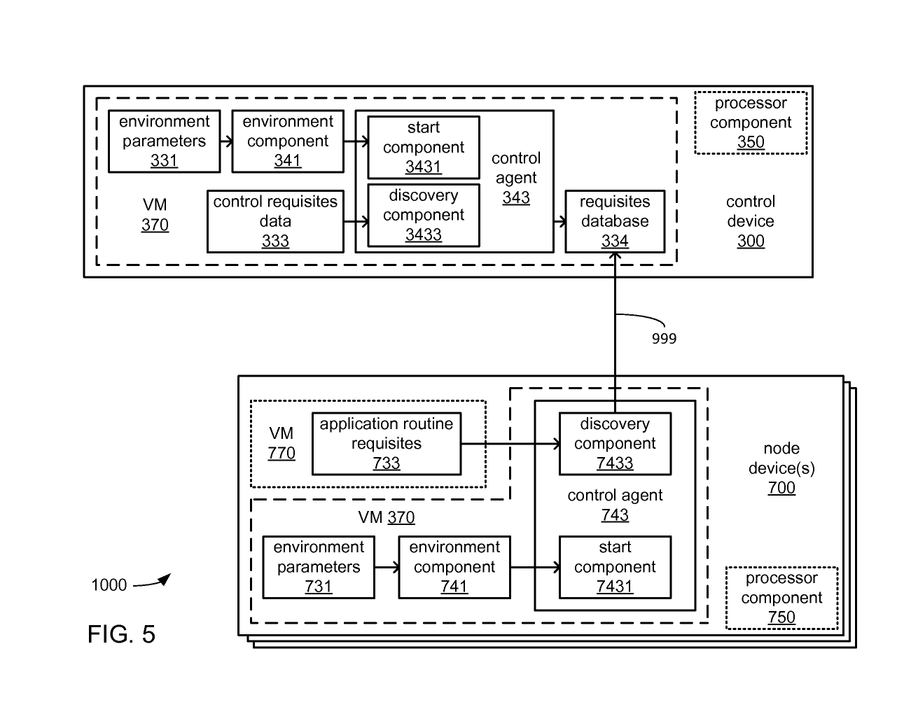

FIG. 5 illustrates a block diagram of aspects of the execution of the control agents 343 and 743 in greater detail. As depicted, a start component 3431 of the control agent 343 may receive an indication from the environment component 341 to allow commencement of execution of the control agent 343 by the processor component 350. In so executing the control agent 343, a discovery component 3433 of the control agent 343 may perform the search for the control requisites data 333 and instances of the application requisites data 733 within the control device 300. As previously discussed, the fact of locating an instance of application requisites data 733 for an application routine 747 may serve as the indication of that application routine 747 having been loaded for execution within the control device 300, and may further serve as the indication of that application routine 747 having been loaded for execution within a particular VM 770 in embodiments in which VMs are employed. The discovery component 3433 may then retrieve indications of requisites for the execution of the control master 347 from the control requisites data 333 and may similarly retrieve indications of requisites for the execution of one or more instances of one or more application routines 747 from corresponding instance(s) of the application routine requisites data 733. Again, these indications of requisites may include indications of requisite pieces of configuration information already provided within the control requisites data 333 and the application requisites data 733, as well as indications of requisite pieces of configuration information that must be provided by the one or more resource devices 500.

Similarly, within each one of the one or more node devices 700 (if there are any present), a start component 7431 of the control agent 743 may receive an indication from the environment component 741 to allow commencement of execution of the control agent 743 by the processor component 750 of that one of the node devices 700. In so executing the control agent 743, a discovery component 7433 of the control agent 743 may perform the search for instances of the application requisites data 733 within that one of the node devices 700. Again, the fact of locating an instance of application requisites data 733 for an application routine 747 may serve as the indication of that application routine 747 having been loaded for execution within that one of the node devices 700, and may further serve as the indication of that application routine 747 having been loaded for execution within a particular VM 770 in embodiments in which VMs are employed. The discovery component 7433 may then retrieval indications of requisites for the execution of one or more application routines 747 from corresponding instance(s) of the application routine requisites 733.

In some embodiments, the discovery components 3433 and/or 7433 may each be a plug-in routine written in, for example, the Ruby™ programming language promulgated by Ruby Central, Inc. of Princeton, N.J. However, it is to be understood that what is described and claimed herein does not require and is not otherwise limited to the use of this particular language or any other particular language. When execution of the control agents 343 and/or 743 commences, the control agents 343 and/or 743 may load the discovery components 3433 and/or 7433, respectively.

As has been discussed, the control master 347 may be accompanied by the control requisites data 333, which may be made up of indications of requisites for executing the control master 347. Similarly, each instance of the one or more application routines 747 may be accompanied by a corresponding one the application requisites data 733, which may be made up of indications of requisites for executing that instance of the one or more application routines 747. As has also been discussed, the indications within each of the control requisites data 333 and each instance of the application requisites data 733 may include indications of requisite pieces of configuration information that need to be supplied by one or more of the resource devices 500. Thus, the searches for the control requisites data 333 and instances of the application requisites data 733, followed by the retrieval of indications of the pieces of information required from the one or more resource devices 500, serve to identify the requisite pieces of configuration information that need to be provided by the one or more resource devices 500. However, to address the possibility that the one or more resource devices 500 may fail to provide at least some of these pieces of configuration information, each of the control requisites data 333 and the application requisites data 733 may also include indications of default settings for those requisite pieces of configuration information.

In some embodiments, the pieces of configuration information required from the one or more resource devices 500 may include configuration information required to communicate with one or more of the resource devices 500 in order to make use of services provided by the one more resource devices 500. Such configuration information may include, but not be limited to, Internet Protocol (IP) address(es) of the one or more resource devices 500 on the network 999, login and/or account information (e.g., account name and password) for use by the control device 300 and/or one or more of the node devices 700 to gain access to services provided by the one or more resource devices 500, etc. Beyond configuration information required from the one or more resource devices 500 to enable communications, configuration information concerning what services are provided by the one or more resource devices 500, limitations on the extent of those services, fees for such services, email contact information to which to send an indication of any errors encountered, etc. may also be required. Alternatively or additionally, configuration information unrelated to contacting one or more resource devices 500 may be required, including and not limited to, IP addresses at which one or more of the VMs 370 and/or 770 may be made accessible on the network 999, login and/or account information by which other devices may access one or more of the VMs 370 and/or 770, firewall and/or filtering settings to limit aspects of the access to one or more of the VMs 370 and/or 770 by other devices, etc. Some of these required pieces of configuration information may be required by more than one of the control master 347 and/or the one or more application routines 740. Thus, in eliminating redundancies in the indications of requisites in generating and/or augmenting the requisites database 334, redundant indications of requisite pieces of configuration information and/or associated default settings may be eliminated.

In addition to performing searches for and retrieving indications of requisites from the control requisites data 333 and instances of the application requisites data 733, the processor components 350 and 750 may be further caused by execution of the discovery components 3433 and 7433 to perform various tests to determine what resources are available within the control device 300 and each of the node devices 700, respectively. Such tests may determine type and/or versions of each of the processor components 350 and/or 750, version levels of firmware of the computing devices 300 and/or 700, type and/or versions of the network interfaces 390 and/or 790 (see FIG. 1), quantities of available storage space within the storages 360 and/or 760, etc.

Following the performances of such tests and/or the retrieval of indications of requisites of the control master 347 from the control requisites data 333 and/or of each instance of the one or more application routines 747 from corresponding ones of the application requisites data 733, the discovery component 3433 of the control agent 343 and the discovery component 7433 of the control agent 743 may cooperate to combine indications of what resources were found in the tests and indications of such requisites to generate the requisites database 334. Thus, the requisites database 334 may become a single data structure made up of indications of requisites for at least the control master 347 and all of the application routines 747, as well as what resources are provided by the control device 300 and/or each of the one or more node devices 700 that may satisfy at least a subset of the requisites. For sake of efficiency, in so creating the requisites database 334, redundant indications of provided resources and/or of requisites may be eliminated.

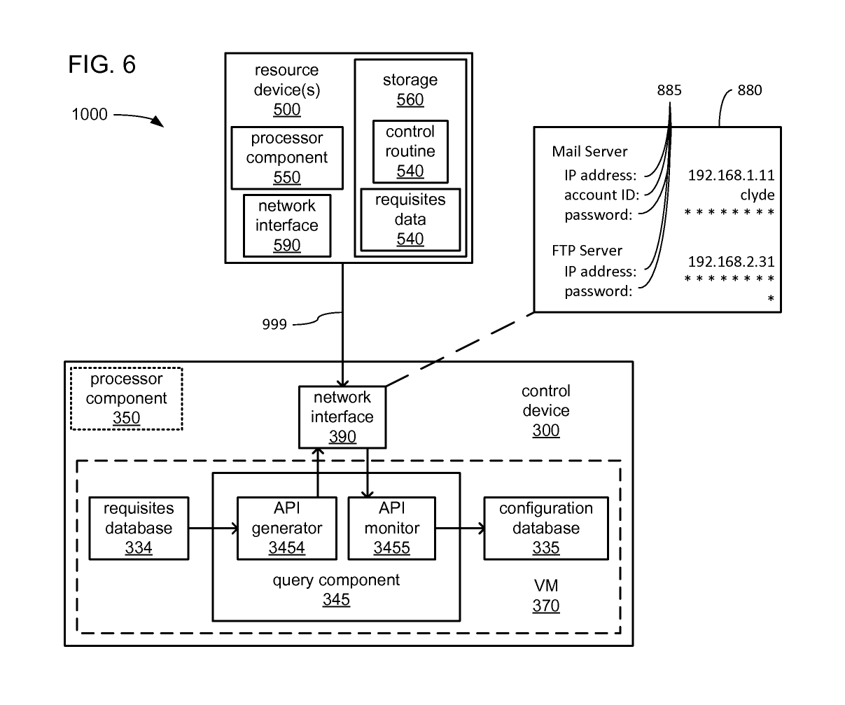

Returning to FIG. 4, following generation and/or augmentation of the requisites database 334, the query component 345 may generate, and make accessible on the network 999, an application programming interface (API) that may be employed by the one or more resource devices 500 to provide the requisite pieces of configuration information that are indicated in the requisites database 334 as needed from the one or more resource devices 500. FIG. 6 illustrates an example of a block diagram of such provision and use of an API on the network 999 in greater detail. As depicted, an API generator 3454 of the query component 345 may receive the requisites database 334, and may parse the requisites database 334 for indications of requisite pieces of configuration information to be received from one or more of the resource devices 500. For each such piece of requisite information, the API generator 3454 may generate an API signature 885 that becomes part of an API that the API generator 3454 may then operate the network interface 390 to make accessible to the one or more resource devices 500 on the network 999 at a particular IP address that may be provided to the one or more resource devices 500. The API generator 3454 may create the API signatures 855 and make the API accessible on the network 999 in a manner that conforms to one or more network protocols, including and not limited to, Hypertext Transfer Protocol (HTTP), Secure Hypertext Transfer Protocol (HTTPS), File Transfer Protocol (FTP), telnet, etc. In so doing, the API generator 3454 may make the API available on the network with at a network port number that normally corresponds with the network protocol that is selected (e.g., port 80h for HTTP).

In the interests of simplifying the use of the API signatures 855 and depending on the network protocol that is selected for use, the API signatures 855 of the API may each be made identifiable by self-explanatory textual identifiers, such as “IP address”, “account ID”, “password”, etc., as depicted in FIG. 6. Such self-explanatory identifiers may be deemed desirable in embodiments in which a protocol enabling a list of the API signatures 855 to be visually presented on a display as in the depicted example webpage 880. In some embodiments, such identifiers may be specified for each piece of requisite configuration that needs to be provided by the one or more resource devices 500 in the control requisites data 333 and/or one or more instances of the application requisites data 733. Such identifiers may include an indication of the routine that requires the piece of information intended to be collected with one or more of the API signatures 855. Alternatively or additionally, such identifiers may include an indication of a version number of the routine they are associated with and/or of a version number of the API of which they are a part. As recognizable to those skilled in the art, from time to time, changes to the API may be needed due to various circumstances that may occur over time, such as the type or format of such requisite pieces of configuration information changing, etc.

By way of example, the requisite piece of configuration information associated with an API signature 885 named with the identifier “password-1.3” may support a password of only up to 8 characters in length, while a later version of that requisite piece of configuration information associated with a newer API signature 885 named with the identifier “password-2.0” may support a password of up to 20 characters. In some embodiments, such indications of versions “1.3” and “2.0” may correspond to older and newer versions of a particular application routine 747 that may have been upgraded from the older version “1.3” to the newer version “2.0” to add a new capability, for example, to accept a longer password as part of enhancing security. In some embodiments, such a newer version of that application routine 747 may be capable of accepting either the longer or shorter passwords, and so both of the API signatures 885 for each of these versions may still be made available for use by a resource device 500 to provide a password. This may enable the requisite pieces of configuration information provided by that resource device 500 to be updated at a later time after the updating of the application routine 740, thereby allowing that resource device 500 to still call the API signatures 885 of the older version of the API to provide the password until the requisite configuration information provided by that resource device 500 is updated and that resource device 500 calls the API signature 885 of the newer version of the API, instead.

As also depicted, an API monitor 3455 of the query component 345 may recurringly monitor use of the API by the one or more resource devices 500 to provide the requisite pieces of configuration information associated with each API signature 885 of the API. In interacting with the API via the network 999, one or more of the resource devices 500 may transmit a request to the control device 300 for a listing of the API signatures 885 making up the API, and the API monitor 3455 may respond by providing such a list. The one or more resource devices 500 may then select particular ones of the API signatures 885 on that list and transmit pieces of the requisite configuration information needed from the one or more resource devices 500 to the control device 300 using those particular ones of the API signatures 885.

The API monitor 3455 may use the pieces of configuration information received from the one or more resource devices 500 to generate the configuration database 335. As previously discussed, the configuration database 335 may be made up of indications of the configuration information derived from tests performed by the discovery components 3433 and/or 7433, configuration information directly provided by the control requisites data 333 and/or instances of the application requisites data 733, and/or by the one or more resource devices 500 and/or specified defaults where the one or more resources devices 500 fail to provide all of the requisite pieces of configuration information expected from them.

In some embodiments, the API monitor 3455 may so generate the configuration database 335 only after all of the API calls 885 have been called by one or more of the resource devices 500 to provide the pieces of requisite configuration information associated with each of those API calls 885. In other embodiments, the API monitor 3455 may so generate the configuration database 335 regardless of whether none, some or all of the pieces of requisite configuration information have been so provided. In those other embodiments, where a piece of requisite configuration information has not yet been so provided, a default value specified in the control requisites data 333 or in an instance of the application requisite data 733 may be used as a substitute for that piece of requisite configuration information in generating the configuration database 335.

In some embodiments, the control requisites data 333, instances of the application requisites data 733, the requisites database 334 and/or the configuration database 335 may be implemented as substantially similar types of files or data structures. As a result, the generation of the requisites database 334 from the control requisites data 333 and/or the application requisites data 733, and/or the generation of the configuration database 335 from the requisites database 334 may entail editing to add and/or change indications of requisites (including configuration information) already identified and/or to be provided by the one or more resource devices 500. By way of example, the indications of requisites and/or of resources found to be provided may be expressed in YAML within each of the control requisites data 333, the instances of the application requisites data 733, the requisites database 334 and/or the configuration database 335 such that the configuration database 335 may be generated by editing the YAML expressions of the requisites database 334, and/or the requisites database 334 may be generated by combining YAML expressions from the control requisites data 333 and the instances of the application requisites data 733.

Returning to FIG. 4, in some embodiments, the control master 347 may generate the control parameter catalog 337 and one or more instances of the application parameter catalog 737, as depicted, such that these catalogs are generated in a centralized manner. However, in other embodiments, generation of the control parameter catalog 337 and instances of the application parameter catalog 737 may be performed in a distributed manner among the control device 300 and one or more node devices 700 by the control agent 343 and/or one or more of the control agents 743, respectively.

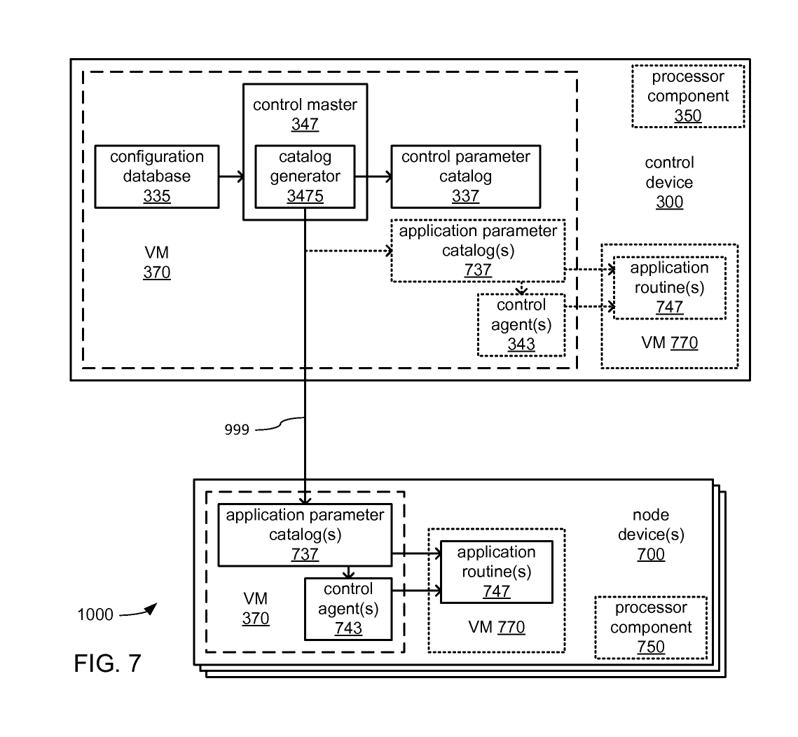

FIG. 7 illustrates a block diagram of an example embodiment of generation of at least the control parameter catalog 337 and/or of one or more instances of the application parameter catalog 737 in a centralized manner in greater detail. A catalog generator 3475 of the control master 347 may use the indications of configuration information in the configuration database 335 to generate at least the control parameter catalog 337. The control parameter catalog 337 may include configuration information retrieved from the configuration database 335 for controlling the operation of the control master 347, itself. The control master 347 may also use the indications of configuration information in the configuration database 335 to generate an instance of the application parameter catalog 737 for the control device 300 in embodiments in which at least one instance of an application routine 740 is to be executed within the control device 300. Such an instance of the application parameter catalog 737 may include configuration information retrieved from the configuration database 335 for controlling the operation of all instances of any application routine 740 that is to be executed within the control device 300. Alternatively or additionally, the control master 347 may use the indications of configuration information in the configuration database 335 to generate an instance of the application parameters catalog 737 for each of the one or more node devices 700. The control master 347 may then transmit each such instance of the application parameters catalog to its corresponding node device 700. For each node device 700, such an instance of the application parameter catalog 737 generated for that node device 700 may include configuration information retrieved from the configuration database 335 for controlling the operation of all instances of any application routine 740 that is to be executed within that node device 700.

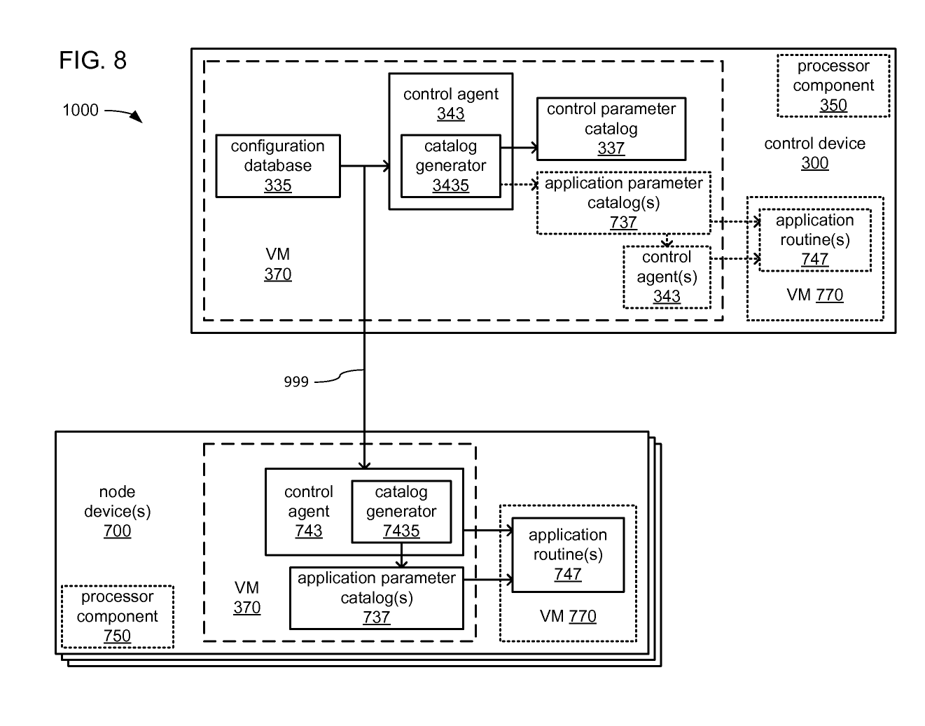

In contrast, FIG. 8 illustrates a block diagram of an example embodiment of generation of the control parameter catalog 337 and one or more instances of the application parameter catalog 737 in a distributed manner in greater detail. The configuration database 335 may be distributed by the processor component 350 of the control device 300 to the one or more node devices 700. A catalog generator 3435 of the control agent 343 may use the indications of configuration information in the configuration database 335 to generate at least the control parameter catalog 337. The catalog generator 3435 may also use the indications of configuration information in the configuration database 335 to generate an instance of the application parameter catalog 737 for the control device 300 in embodiments in which at least one instance of an application routine 740 is to be executed within the control device 300. Correspondingly, within each one of the one or more node devices 700, a catalog generator 7435 of the control agent 743 may use the indications of configuration information in the configuration database 335 to generate an instance of the application parameters catalog 737 for use within that one of the node devices 700. Again, for each one of the one or more node devices 700, the instance of the application parameter catalog 737 generated within that one of the node devices 700 may include configuration information retrieved from the configuration database 335 for controlling the operation of all instances of any application routine 740 that is to be executed within that one of the one or more node devices 700.

Returning to FIG. 4, regardless of the exact manner in which each instance of the application parameter catalog 737 is generated and/or provided to a corresponding one of the node devices 700, within the control device 300 and/or within each one of the one or more node devices 700, the control agents 343 and/or 743 may use the configuration information within the instance of the application parameter catalog 737 generated for that device 300 and/or 700 to control the execution of any instance of one or more of the application routines 747 within that device 300 and/or 700, respectively. More specifically, the control agent 343 of the control device 300 and/or the control agent 743 of each of the node devices 700 may refrain from enabling the execution of instance(s) of application routine(s) 747 to commence until the control agents 343 and/or 743 are provided with an instance of the application parameter catalog 737. Once provided with that instance of the application parameter catalog 737, the control agents 343 and/or 743 may control the order in which the execution of each instance of each application routine 747 within that device 300 and/or 700, respectively, commences based on indications of dependencies thereamong that may be present in the that instance of the application parameter catalog 737. The control agent 343 of the control device 300 and/or the control agents 743 of each of the node devices 700 may also provide each instance of each application routine 747 to be executed on the device(s) with the configuration information indicated within that instance of the application parameter catalog 737 as needed by each, including the pieces of requisite configuration information received from the one or more resource devices 500.

In embodiments in which the control parameter catalog 337 and all instances of the application parameter catalog 737 are generated in a centralized manner by the control master 347, one or more of the control agents 343 and/or 743 may receive indications from the control master 347 that the control parameter catalog 337 and/or one or more instances of the application parameter catalog 737 are available. This may trigger the control agent 343 and/or one or more of the control agents 743 to request that the control master 347 provide a parameter catalog. The control master 347 may provide such indications to the control agent(s) 343 and/or 743 regardless of whether or not all pieces of requisite configuration information awaited from the one or more resource devices 500 have been provided thereby through the API. Again, in situations in which not all of such pieces of requisite configuration information have been provided, default values may be substituted for the otherwise missing configuration information in generating the configuration database 335 from which the parameter catalogs 337 and 737 may be generated. Again, such default values may be provided in the control requisites data 333 and/or instance(s) of the application requisites data 733.

Following commencement of execution of the various instances of the one or more application routines 747 that may occur within the control device 300 and/or one or more node devices 700, the tests and/or searches for the control requisites data 333 and any instances of the application requisites data 733, the generation of the requisites database 334, the generation of API signatures 885, the generation of the configuration database 335 and/or the generation of the parameter catalogs 337 and/or 737 may be repeated at regular intervals and/or on another recurring basis. In some embodiments, such a regular interval may be 30 minutes in length. Such repetition may be employed to cause the updating of the requisites database 334, the configuration database 335 and/or the parameter catalogs 337 and/or 737 to reflect changes that may have occurred to one or more of the computing devices 300 and/or 700, to one or more of the VMs 370 and/or 770, to one or more of the routines executed by the processor components 350 and/or 750, and/or to one or more of the resources. More specifically, such repetition may be employed to cause such updates to be made to reflect the delayed provision of requisite pieces of configuration information provided by a resource device 500 by calling one or more of the API signatures 885 such that default configuration information to be used lieu of such requisite pieces of configuration information may be replaced thereby. Alternatively or additionally, such repetition may be employed to cause such updates to be made to reflect changes to requisite pieces of configuration information provided by a resource device 500 by calling one or more of the API signatures 885.

Among the changes that may occur may be changes in one or more of the control requisites data 333 and/or an instance of the application requisites data 733 that changes what pieces of configuration information need to be provided by one or more of the resource devices 500. As previously discussed, changes in the configuration information needed from the resource device(s) 500 may necessitate changes in the API signatures 885 of the API made available by the API generator 3454 of the query component 345 on the network 999 for use by the one or more resource devices 500. Again, such changes to the API may arise from the addition of and/or an update or other change to a routine that requires configuration information from one or more of the resource devices 500, such as the control master 347 and/or one of the application routines 747. As also previously discussed, accommodation may be made for a delay in making corresponding changes to one or more of the resource devices 500 by continuing to provide already existing API signatures 885 for use by the resource device(s) 500 even as new or altered versions of API signatures 885 are generated and also made available to the resource device(s) 500.

Regardless of whether there is a change to the API signatures 885, the API monitor 3455 of the query component 345 may continue to monitor for any API calls made to any of the API signatures 885 during intervals of time between the generation of the configuration database 335. The API monitor 3455 may maintain new pieces of configuration information provided by one or more of the resource devices 500 during those intervals of time to enable such new pieces of configuration information so provided are included in a new version of the configuration database 335 when the generation of the configuration database 335 is subsequently repeated by the API monitor 3455.

Following generation of a new version of the configuration database 335, either the control master 347 (or the control agents 343 and/or 743) may generate new versions of the parameter catalogs 337 and/or 737 based on the new version of the configuration database 335. Following the generation of new versions of the parameter catalogs 337 and/or 737, the control master 347 may provide indications to the control agents 343 and/or 743 of the availability of new versions of the parameter catalogs 337 and/or 737, and may provide the parameter catalogs 337 and/or 737 to the control agents 343 and/or 743, respectively, in response to a request received therefrom to do so. However, instead of the control agents 343 and/or 743 employing these new versions of the parameter catalogs 337 and/or 737 to control the start of execution of various routines, the control agents 343 and/or 743 may employ the new versions of the parameter catalogs 337 and/or 737, respectively, to check for differences in which routines are to be executed. More specifically, the control agents 343 and/or 743 may check to determine whether there are any changes in which application routines 747 are to be executed, and may enact such changes, including causing the commencement of execution of additional instances of one or more of the application routines 747 and/or commencement of execution of a new application routine 747. During such a check for differences in which routines are to be executed, one of the control agents 343 and/or 743 may detect a failure in the execution of an application routine 747 that was previously already being executed and is supposed to continue to be executed. In response, that control agent 743 may cause the restarting of execution of that application routine 747.

Also Following commencement of execution of the various instances of the one or more application routines 747 that may occur within the control device 300 and/or one or more node devices 700, each such instance of each application routine 747 may monitor various aspects of its own execution, including and not limited to, the resources upon which it depends. As a result of a change to an application parameter catalog 737, a resource upon which execution of an application routine 747 relies may have been changed such that execution of that application routine 747 needs to be restarted. Among such changes may be a change in configuration information associated with a resource provided for that application routine 747 by one of the resource devices 500. Again, it may be that one of the resource devices 500 did not make API calls to one or more of the API signatures 885 of the API such until after execution of that application routine 747 had already commenced such that pieces of default configuration information were used. With that resource device 500 having subsequently made API calls to one or more of those API signatures 885 to belatedly provide pieces of configuration information, that application routine 747 may now need to be restarted to make use of that configuration information in place of the pieces of default configuration information.

In embodiments in which there are dependencies among instances of application routines 747 or among two or more different application routines 740, the control agents 343 and/or 743 may act to ensure that those dependencies are accommodated when a restart of one or more instances of an application routine 747 is needed. Specifically, where an instance of application routine 747 needs to be restarted, the control agents 343 and/or 743 may cooperate to cause the restarting of other instances of other application routines 747 that are in some way dependent upon that one instance of that one application routine 747.

The use of searches for information concerning requisites of one or more application routines 747 within the control device 300 and/or the one or more node devices 700 may allow the configuration of each instance of each of the one or more application routines 747 to be dynamic. Alternatively or additionally, the recurring monitoring for changes to configuration information required for the execution of the one or more application routines 747, including changes to pieces of configuration information from the one or more resource devices 500, coupled with the re-generation of the parameter catalogs 337 and 737 therefrom, may allow the configuration of each instance of each of the one or more application routines 740 to be dynamic. More simply, the configuration information required by each instance of each application routine 747 is made more easily changeable in response to changes in computing devices (e.g., upgrades or updates) and/or changes in access to other computing devices (e.g., the one or more resource devices 500).

Returning to FIG. 1, in various embodiments, each of the resource devices 500 may incorporate one or more of a processor component 550, a storage 560 and an interface 590 to couple the resource device 500 to the network 999. The storage 560 may store one or both of a control routine 540 and configuration data 535. The control routine 540 may incorporate a sequence of instructions operative on the processor component 550 to implement logic to perform various functions when executed by the processor component 550.

In executing the control routine 540, the processor component 550 may either recurringly attempt to reach the control device 300 at the IP address at which the API is to be made available until the API is made so available, or await receipt of a message from the control device 300 via the network that indicates that the API is currently so available. The processor component 550 may then operate the network interface 590 to transmit to the control device 300 at that IP address on the network 999 a request for a listing of API signatures 885 making up the API. Upon receiving that list from the control device 300 via the network 999, the processor component 540 may then select one or more of the API signatures 885 in that list to make API calls to, and may do so based on what pieces of requisite configuration information are included in the configuration data 535. The processor component 550 may then operate the network interface 590 transmit API calls to those selected ones of the API signatures 885, in which the processor component 550 may include a piece of requisite configuration information that corresponds to each of those API signatures 885 from the configuration data. The processor component 550 may then be caused to await being contacted by the control device 300 and/or one or more node devices 700 to request access to services.

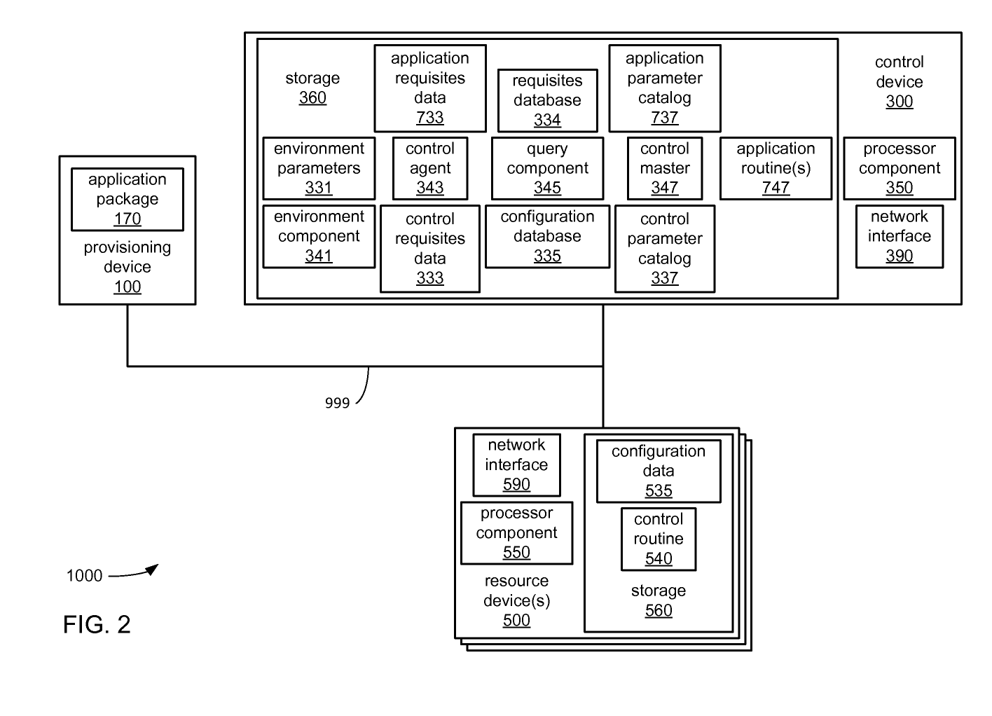

FIG. 2 illustrates a block diagram of an alternate example embodiment of the online services system 1000 in which all instances of any application routines 740 are executed within the control device 300, and there are no node devices 700, unlike the online services system 1000 of FIG. 1. Thus, in FIG. 2, there may be no instances of the control agent 743 or the environment component 741 executed within the online services system 1000, and there may be only instance of the application parameter catalog 737 that is generated by either of the control master 347 or the control agent 343.

Returning to FIGS. 1 and 2, in various embodiments, each of the processor components 350, 550 and 750 may include any of a wide variety of commercially available processors. Further, one or more of these processor components may include multiple processors, a multi-threaded processor, a multi-core processor (whether the multiple cores coexist on the same or separate dies), and/or a multi-processor architecture of some other variety by which multiple physically separate processors are linked.

In various embodiments, each of the storages 360, 560 and 760 may be based on any of a wide variety of information storage technologies, including volatile technologies requiring the uninterrupted provision of electric power, and/or including technologies entailing the use of machine-readable storage media that may or may not be removable. Thus, each of these storages may include any of a wide variety of types (or combination of types) of storage component, including without limitation, read-only memory (ROM), random-access memory (RAM), dynamic RAM (DRAM), Double-Data-Rate DRAM (DDR-DRAM), synchronous DRAM (SDRAM), static RAM (SRAM), programmable ROM (PROM), erasable programmable ROM (EPROM), electrically erasable programmable ROM (EEPROM), flash memory, polymer memory (e.g., ferroelectric polymer memory), ovonic memory, phase change or ferroelectric memory, silicon-oxide-nitride-oxide-silicon (SONOS) memory, magnetic or optical cards, one or more individual ferromagnetic disk drives, or a plurality of storage components organized into one or more arrays (e.g., multiple ferromagnetic disk drives organized into a Redundant Array of Independent Disks array, or RAID array). It should be noted that although each of these storages is depicted as a single block, one or more of these may include multiple storage components that may be based on differing storage technologies. Thus, for example, one or more of each of these depicted storages may represent a combination of an optical drive or flash memory card reader by which programs and/or data may be stored and conveyed on some form of machine-readable storage media, a ferromagnetic disk drive to store programs and/or data locally for a relatively extended period, and one or more volatile solid state memory devices enabling relatively quick access to programs and/or data (e.g., SRAM or DRAM). It should also be noted that each of these storages may be made up of multiple storage components based on identical storage technology, but which may be maintained separately as a result of specialization in use (e.g., some DRAM devices employed as a main storage while other DRAM devices employed as a distinct frame buffer of a graphics controller).

In various embodiments, each of the interfaces 390, 590 and 790 may employ any of a wide variety of communications technologies enabling these computing devices to be coupled to other devices as has been described. Each of these interfaces includes circuitry providing at least some of the requisite functionality to enable such coupling. However, each of these interfaces may also be at least partially implemented with sequences of instructions executed by corresponding ones of the processor components (e.g., to implement a protocol stack or other features). Where electrically and/or optically conductive cabling is employed, these interfaces may employ timings and/or protocols conforming to any of a variety of industry standards, including without limitation, RS-232C, RS-422, USB, Ethernet (IEEE-802.3) or IEEE-1394. Where the use of wireless transmissions is entailed, these interfaces may employ timings and/or protocols conforming to any of a variety of industry standards, including without limitation, IEEE 802.11a, 802.11b, 802.11g, 802.16, 802.20 (commonly referred to as “Mobile Broadband Wireless Access”); Bluetooth; ZigBee; or a cellular radiotelephone service such as GSM with General Packet Radio Service (GSM/GPRS), CDMA/1xRTT, Enhanced Data Rates for Global Evolution (EDGE), Evolution Data Only/Optimized (EV-DO), Evolution For Data and Voice (EV-DV), High Speed Downlink Packet Access (HSDPA), High Speed Uplink Packet Access (HSUPA), 4G LTE, etc.

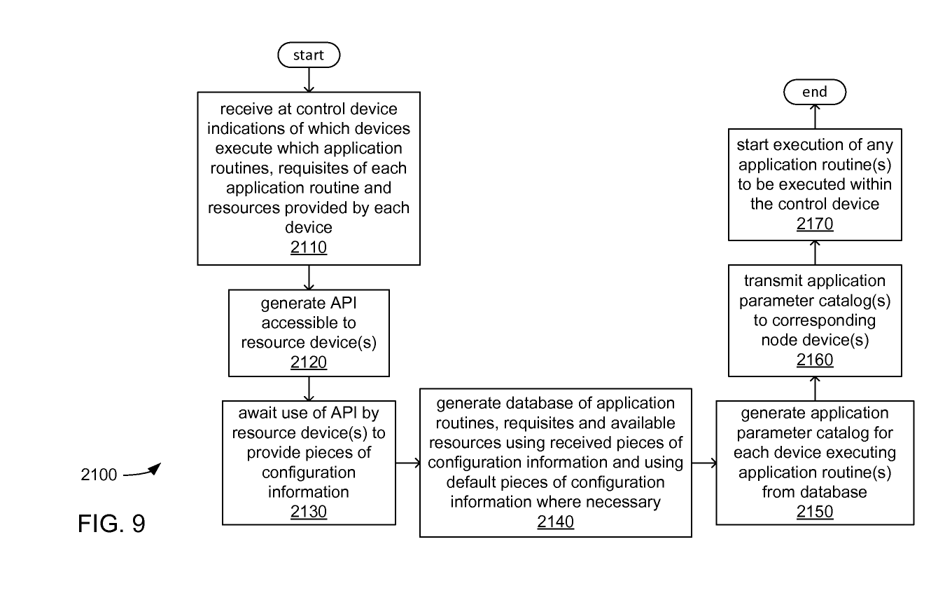

FIG. 9 illustrates an example embodiment of a logic flow 2100. The logic flow 2100 may be representative of some or all of the operations executed by one or more embodiments described herein. More specifically, the logic flow 2100 may illustrate operations performed by the processor component 350 of the control device 300 in executing one or more of the control agent 343, the query component 345, the control master 347 and instance(s) of the one or more application routines 747, and/or performed by other component(s) of the control device 300.

At 2110, a processor component of a control device (e.g., the processor component 350 of the control device 300) may receive indications from one or more node devices (e.g., one or more of the node devices 700) of which one(s) of the one or more node devices are to execute various application routines (e.g., one or more of the application routines 747). Along with those indications, the processor component may also receive indications of requisites for the execution of each of those various application routines from the one or more node devices, as well as indications of resources provided by each of the one or more node devices. As has been discussed, among the requisites of an application routine may be a resource required of one or more resource devices (e.g., the one or more resource devices 500).

At 2120, the processor component may generate an API and make the API available on a network coupling the control device to the one or more resource devices. As has been discussed, this may enable the one or more resource devices to make API calls to various API signatures (e.g., the API signatures 885) of the API to provide pieces of configuration information that have been indicated as required by one or more of the application routines. At 2130, the processor component may await the use of the API by the one or more resource devices to provide the pieces of configuration information required from the one or more resource devices.

At 2140, based at least on configuration information obtained from searches for requisites and/or testing for resources provided, as well as indications of configuration information provided by the one or more resource devices via the API, the processor component may generate a configuration database (e.g., the configuration database 335). As has been discussed, where pieces of configuration information required from the one or more resource devices have failed to be provided, one or more default pieces of configuration information may be used, instead, in generating the configuration database.

At 2150, the processor component may generate separate parameter catalogs (e.g., the control parameter catalog 337 and/or one or more instances of the application parameter catalog 737) for at least each device that is to execute an application routine (e.g., the control device 300 and/or one or more of the node devices 700) from the configuration database. As has been discussed, each of those parameter catalogs may include configuration information for the particular one(s) of the application routines to be executed within the particular device for which it is generated, including indications of configuration information received from the one or more resource devices.

At 2160, the processor component may transmit one or more of those parameter catalogs to the particular node device(s) the one or more parameter catalogs were generated. At 2170, the processor component may use an application parameter catalog generated to support the execution of any application routines that may be intended to be executed within the control device to commence such execution of such application routines within the control device (if there are any application routines to be executed within the control device).

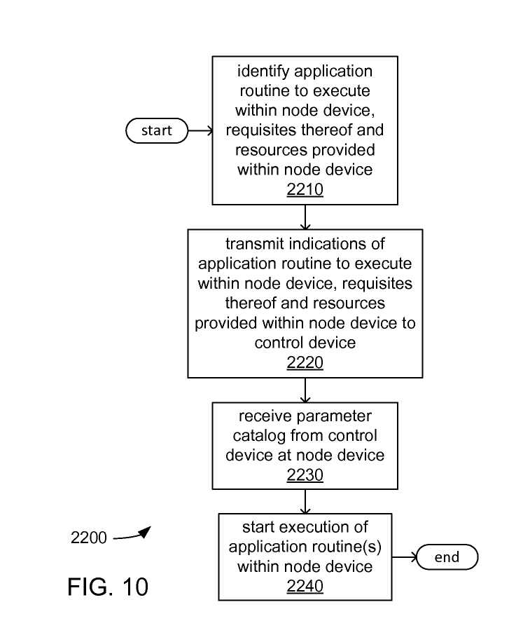

FIG. 10 illustrates an example embodiment of a logic flow 2200. The logic flow 2200 may be representative of some or all of the operations executed by one or more embodiments described herein. More specifically, the logic flow 2200 may illustrate operations performed by the processor component 750 of one of the node devices 700 in executing one or more of the control agent 743 and instance(s) of the one or more application routines 747, and/or performed by other component(s) of that one of the node devices 700.

At 2210, a processor component of a node device (e.g., the processor component 750 of one of the one or more node devices 700) may perform various searches within the node device to identify what application routines (e.g., which of one or more application routines 747) are to be executed within the node device, and what are the requisites for each of those application routines. As has been discussed, among those requisites may be pieces of configuration information that need to be provided by one or more resource devices (e.g., the one or more resource devices 500). As has also been discussed, various default pieces of configuration information may also be provided for use in lieu of receiving the requisite pieces of configuration information needed from at least one of the resource devices. The processor component may also perform various tests to determine the resources provided by the node device for the execution of application routines (e.g., the environment component 741 to provide a VM 770 in an embodiment in which VMs are used).

At 2220, the processor component may transmit indications of what application routines are to be executed within the node device, the requisites of each of those application routines and/or what resources the node device provides to support the execution of application routines to a control master of a control device (e.g., the control master 347 of the control device 300) with which the node device cooperates to execute application routines. Among the indications of requisites provided to the control device may be indications of pieces of configuration information required to be provided by the one or more resource devices.

At 2230, an application parameter catalog may be received by the processor component of the node device from the control master of the control device. Among the configuration information within the parameter catalog may be indications of pieces of configuration information provided by one or more of the resource devices and/or pieces of default configuration information supplied in lieu of pieces of configuration information that has not yet been provided by at least one of the resource devices. As has been discussed, the transmission of parameter catalogs by the control master of the control device to one or more node devices may follow an exchange of indications in which the control device first transmits an indication of the availability of the parameter catalogs to the one or more node devices, then awaits request(s) transmitted by the one or more node devices for their corresponding one(s) of the parameter catalogs before transmitting the parameter catalog(s) to the one or more nodes. At 2240, the processor component may commence execution of one or more application routines to be executed within the node device.

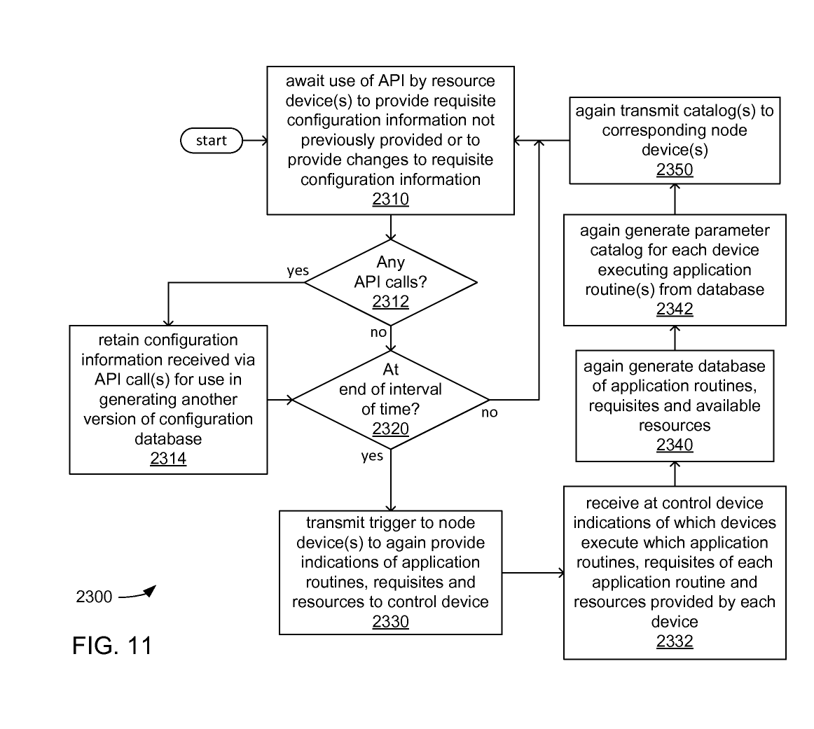

FIG. 11 illustrates an example embodiment of a logic flow 2300. The logic flow 2300 may be representative of some or all of the operations executed by one or more embodiments described herein. More specifically, the logic flow 2300 may illustrate operations performed by the processor component 350 of the control device 300 in executing one or more of the control agent 343, the query component 345 and the control master 347, and/or performed by other component(s) of the control device 300.

At 2310, a processor component of a control device (e.g., the processor component 350 of the control device 300) may await the receipt of API calls from one or more resource devices via a network to API signatures of an API (e.g., API calls from the one or more resource devices 500 to the API signatures 885) to convey requisite pieces of configuration information not previously provided and/or updates to requisite pieces of earlier provided configuration information. As has been discussed, the control device may make available an API of API signatures callable through a network by one or more resource devices to enable those resource devices to provide pieces of configuration information to the control device that are needed for the execution of one or more application routines that may require services provided by the one or more resource devices.

If, at 2312, no such API calls have been received, then the processor component may check whether sufficient time has passed that a current interval of a repeating interval of time has come to an end. However, if at 2312, one or more of such API calls have been received, then the configuration information received from the one or more resource devices in those API calls may be stored at 2314 in preparation for inclusion in the next configuration database (e.g., the configuration database 335) when the next configuration database is generated. Following such storage, the processor component may perform the check at 2312.

If, at 2320, the end of the current interval of time has not been reached, then the processor component may return to awaiting use of the API at 2310. However, if at 2320, the end of the current interval of time has been reached, then at 2330, the processor component may transmit a command, a request or other form of trigger to one or more node devices (e.g., one or more of the node devices 700) to once again provide the control device with indications of which one(s) of the one or more node devices are to execute various application routines (e.g., one or more of the application routines 747). Along with those indications, the one or more node devices may also be triggered to provide indications of requisites for the execution of each of those various application routines. Again, among the requisites of an application routine may be a resource required of one or more of the resource devices by one or more of the application routines. Further, the one or more node devices may be triggered to provide indications of resources provided within each of those one or more node devices. At 2332, the processor component may receive such indications from the one or more node devices.

At 2340, based at least on one or more of the aforementioned received indications, the processor component may again generate a database (e.g., the configuration database 335) of the application routines to be executed, the requisites of those application routines and/or the resources available from each device to supply those requisites. Again, such a database may include indications of requisite resources provided by one or more of the resource devices to one or more of the application routines, as well as indications of pieces of configuration information received from the one or more resource devices enabling access and/or use of those resources.

At 2342, the processor component may again generate separate parameter catalogs (e.g., the control parameter catalog 337 and/or one or more instances of the application parameter catalog 737) for at least each device that is to execute an application routine (e.g., the control device 300 and/or one or more of the node devices 700) from the database. Again, each of those parameter catalogs may include configuration information for the particular one(s) of the application routines to be executed within the particular device for which it is generated, including indications of any resource required of one or more of the resource devices and/or configuration information required to access and/or make use of those resources. At 2350, the processor component may transmit one or more of those re-generated parameter catalogs to the particular node device(s) the one or more parameter catalogs were generated, before returning to awaiting use of the API at 2310.

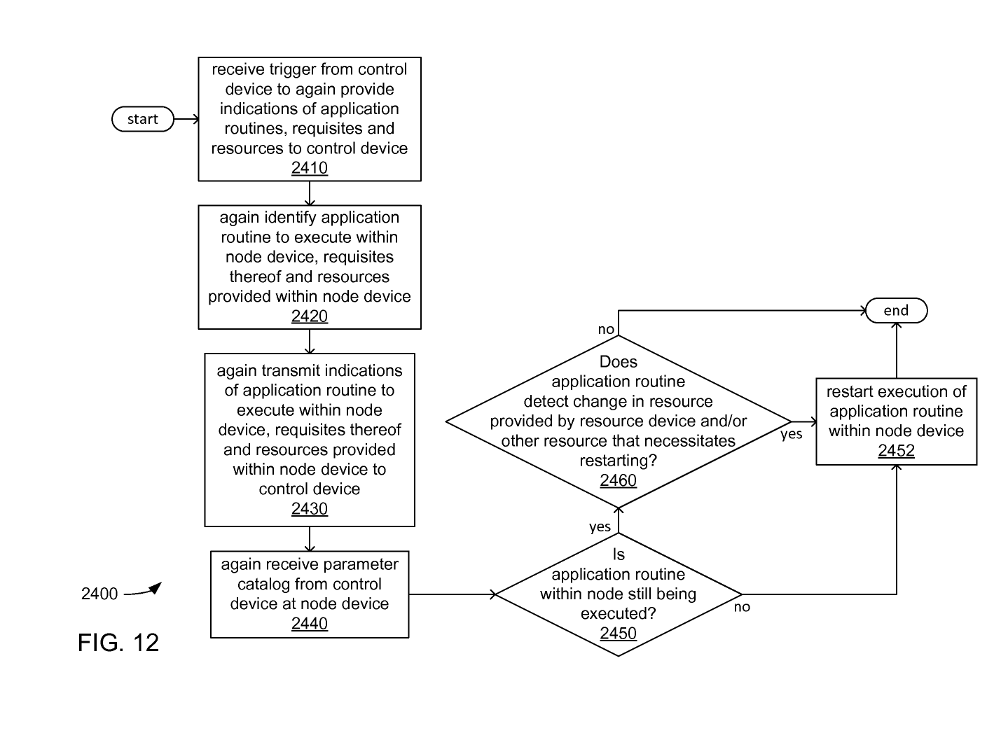

FIG. 12 illustrates an example embodiment of a logic flow 2400. The logic flow 2400 may be representative of some or all of the operations executed by one or more embodiments described herein. More specifically, the logic flow 2400 may illustrate operations performed by the processor component 750 of one of the node devices 700 in executing one or more of the control agent 743 and instance(s) of the one or more application routines 747, and/or performed by other component(s) of that one of the node devices 700.

At 2410, a processor component of a node device (e.g., the processor component 750 of one of the one or more node devices 700) may receive a command, a request or other form of trigger from a control device (e.g., the control device 300) to again provide the control device with indications of what application routines (e.g., one or more of the application routines 747) are to be executed within the node device, what are the requisites for the execution of each of those various application routines, and what resources are provided within the node device to support the execution of application routines. Again, among the requisites of an application routine may be one or more pieces of configuration information required from one or more resource devices (e.g., the one or more resource devices 500) to enable one or more of the application routines to make use of those resources. As also discussed, such indications of requisite pieces of configuration information that need to be provided by one or more of the resource devices may be accompanied by indications of default configuration information to be used if at least a subset of the pieces of configuration information needed from the one or more resource devices is not provided.

At 2420, in response to the trigger, the processor component of a node device may again perform various searches within the node device to identify what application routines are to be executed within the node device, and the requisites for each of those application routines. The processor component may also again perform various tests to identify the resources provided by the node device for the execution of application routines (e.g., the environment component 741 to provide a VM 770). At 2430, the processor component may again transmit indications of what application routines are to be executed within the node device, the requisites of each of those application routines and/or what resources the node device provides to support the execution of application routines to the control device.

At 2440, a parameter catalog may again be received by the processor component of the node device from the control master of the control device. Among the configuration information within the parameter catalog may be indications of resources required by one or more application routines and/or indications of pieces of requisite configuration information that may have been received from the one or more resource devices through an API made available on a network by the control device to enable the one or more resource devices to provide such configuration information. Again, the transmission of parameter catalogs by the control master of the control device to one or more node devices may follow an exchange of indications in which the control device first transmits an indication of the availability of the parameter catalogs to the one or more node devices, then awaits request(s) transmitted by the one or more node devices for their corresponding one(s) of the parameter catalogs before transmitting the parameter catalog(s) to the one or more nodes.

At 2450, in response to receiving the parameter catalog, the processor component may check whether an application routine for which execution was earlier started is still being executed. If not (or if the application routine has otherwise become nonfunctional, such as becoming unresponsive), then the processor component may restart execution of that application routine at 2452.

However, if at 2450, the application routine is still being successfully executed, then at 2460, the processor component may check whether the application routine has detected a change in a resource that it requires such that the application routine needs to be restarted in response to that change. By way of example, it may be that a resource device that provides a resource required by the application routine 747 has belated provided configuration information and/or has provided an update to earlier provided configuration information. If, at 2460, the application routine has detected such a change such that the application routine needs to be restarted, then the processor component may restart execution of that application routine at 2452.

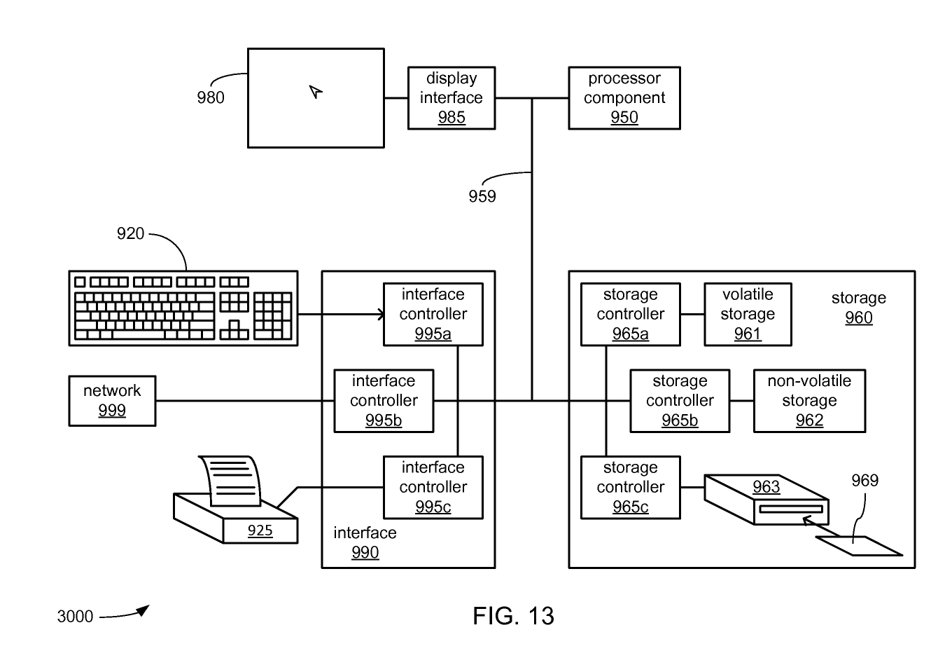

FIG. 13 illustrates an example embodiment of a processing architecture 3000 suitable for implementing various embodiments as previously described. More specifically, the processing architecture 3000 (or variants thereof) may be implemented as part of one or more of the computing devices 300, 500 or 700, or the controller 600. It should be noted that components of the processing architecture 3000 are given reference numbers in which the last two digits correspond to the last two digits of reference numbers of at least some of the components earlier depicted and described as part of the computing devices 300, 500 and 700, as well as the controller 600. This is done as an aid to correlating components of each.

The processing architecture 3000 includes various elements commonly employed in digital processing, including without limitation, one or more processors, multi-core processors, co-processors, memory units, chipsets, controllers, peripherals, interfaces, oscillators, timing devices, video cards, audio cards, multimedia input/output (I/O) components, power supplies, etc. As used in this application, the terms “system” and “component” are intended to refer to an entity of a computing device in which digital processing is carried out, that entity being hardware, a combination of hardware and software, software, or software in execution, examples of which are provided by this depicted exemplary processing architecture. For example, a component can be, but is not limited to being, a process running on a processor component, the processor component itself, a storage component (e.g., a hard disk drive, multiple storage drives in an array, etc.) that may employ an optical and/or magnetic storage medium, an software object, an executable sequence of instructions, a thread of execution, a program, and/or an entire computing device (e.g., an entire computer). By way of illustration, both an application running on a server and the server can be a component. One or more components can reside within a process and/or thread of execution, and a component can be localized on one computing device and/or distributed between two or more computing devices. Further, components may be communicatively coupled to each other by various types of communications media to coordinate operations. The coordination may involve the uni-directional or bi-directional exchange of information. For instance, the components may communicate information over the communications media. The information can be implemented as transmissions allocated to one or more electrical and/or optical conductors. A message (including a command, status, address or data message) may be one of such transmissions or may be a plurality of such transmissions, and may be transmitted either serially or substantially in parallel through any of a variety of connections and/or interfaces.

As depicted, in implementing the processing architecture 3000, a computing device includes at least a processor component 950, a storage 960, an interface 990 to other devices, and a coupling 959. As will be explained, depending on various aspects of a computing device implementing the processing architecture 3000, including its intended use and/or conditions of use, such a computing device may further include additional components, such as without limitation, a touch screen 980 incorporating a display interface 985.

The coupling 959 includes one or more buses, point-to-point interconnects, transceivers, buffers, crosspoint switches, and/or other conductors and/or logic that communicatively couples at least the processor component 950 to the storage 960. Coupling 959 may further couple the processor component 950 to one or more of the interface 990, the audio subsystem 970 and the display interface 985 (depending on which of these and/or other components are also present). With the processor component 950 being so coupled by couplings 955, the processor component 950 is able to perform the various ones of the tasks described at length, above, for whichever one(s) of the aforedescribed computing devices implement the processing architecture 3000. Coupling 959 may be implemented with any of a variety of technologies or combinations of technologies by which commands and/or data are optically and/or electrically conveyed. Further, at least portions of couplings 955 may employ timings and/or protocols conforming to any of a wide variety of industry standards, including without limitation, Accelerated Graphics Port (AGP), CardBus, Extended Industry Standard Architecture (E-ISA), Micro Channel Architecture (MCA), NuBus, Peripheral Component Interconnect (Extended) (PCI-X), PCI Express (PCI-E), Personal Computer Memory Card International Association (PCMCIA) bus, HyperTransport™, QuickPath, and the like.

As previously discussed, the processor component 950 (corresponding to the processor components 350 and 550) may include any of a wide variety of commercially available processors, employing any of a wide variety of technologies and implemented with one or more cores physically combined in any of a number of ways.

As previously discussed, the storage 960 (corresponding to the storages 360 and 560) may be made up of one or more distinct storage components based on any of a wide variety of technologies or combinations of technologies. More specifically, as depicted, the storage 960 may include one or more of a volatile storage 961 (e.g., solid state storage based on one or more forms of RAM technology), a non-volatile storage 962 (e.g., solid state, ferromagnetic or other storage not requiring a constant provision of electric power to preserve their contents), and a removable media storage 963 (e.g., removable disc or solid state memory card storage by which information may be conveyed between computing devices). This depiction of the storage 960 as including multiple distinct types of storage is in recognition of the commonplace use of more than one type of storage component in computing devices in which one type provides relatively rapid reading and writing capabilities enabling more rapid manipulation of data by the processor component 950 (but in which a “volatile” technology may be used constantly requiring electric power) while another type provides relatively high density of non-volatile storage (but likely provides relatively slow reading and writing capabilities).

Given the often different characteristics of different storage components employing different technologies, it is also commonplace for such different storage components to be coupled to other portions of a computing device through different storage controllers coupled to their differing storage components through different interfaces. By way of example, where the volatile storage 961 is present and is based on RAM technology, the volatile storage 961 may be communicatively coupled to coupling 959 through a storage controller 965a providing an appropriate interface to the volatile storage 961 that perhaps employs row and column addressing, and where the storage controller 965a may perform row refreshing and/or other maintenance tasks to aid in preserving information stored within the volatile storage 961. By way of another example, where the non-volatile storage 962 is present and includes one or more ferromagnetic and/or solid-state disk drives, the non-volatile storage 962 may be communicatively coupled to coupling 959 through a storage controller 965b providing an appropriate interface to the non-volatile storage 962 that perhaps employs addressing of blocks of information and/or of cylinders and sectors. By way of still another example, where the removable media storage 963 is present and includes one or more optical and/or solid-state disk drives employing one or more pieces of machine-readable storage medium 969, the removable media storage 963 may be communicatively coupled to coupling 959 through a storage controller 965c providing an appropriate interface to the removable media storage 963 that perhaps employs addressing of blocks of information, and where the storage controller 965c may coordinate read, erase and write operations in a manner specific to extending the lifespan of the machine-readable storage medium 969. The machine-readable storage medium 969, with executable instructions stored thereon, may be an example embodiment of a computer-program product that may or may not be fabricated in large quantities to enable distribution of those executable instructions.

One or the other of the volatile storage 961 or the non-volatile storage 962 may include an article of manufacture in the form of a machine-readable storage media on which a routine including a sequence of instructions executable by the processor component 950 may be stored, depending on the technologies on which each is based. By way of example, where the non-volatile storage 962 includes ferromagnetic-based disk drives (e.g., so-called “hard drives”), each such disk drive typically employs one or more rotating platters on which a coating of magnetically responsive particles is deposited and magnetically oriented in various patterns to store information, such as a sequence of instructions, in a manner akin to storage medium such as a floppy diskette. By way of another example, the non-volatile storage 962 may be made up of banks of solid-state storage components to store information, such as sequences of instructions, in a manner akin to a compact flash card. Again, it is commonplace to employ differing types of storage components in a computing device at different times to store executable routines and/or data. Thus, a routine including a sequence of instructions to be executed by the processor component 950 may initially be stored on the machine-readable storage medium 969, and the removable media storage 963 may be subsequently employed in copying that routine to the non-volatile storage 962 for longer term storage not requiring the continuing presence of the machine-readable storage medium 969 and/or the volatile storage 961 to enable more rapid access by the processor component 950 as that routine is executed.

As previously discussed, the interface 990 (which may correspond to the interfaces 590 or 790) may employ any of a variety of communications technologies corresponding to any of a variety of communications technologies that may be employed to communicatively couple a computing device to one or more other devices. Again, one or both of various forms of wired or wireless communications may be employed to enable the processor component 950 to interact with input/output devices (e.g., the depicted example keyboard 920 or printer 925) and/or other computing devices, where such interaction may be through a network (e.g., the network 999) or an interconnected set of networks. In recognition of the often greatly different character of multiple types of timings and/or protocols that must often be supported by any one computing device, the interface 990 is depicted as including multiple different interface controllers 995a, 995b and 995c. The interface controller 995a may employ any of a variety of types of wired digital serial interface or radio frequency wireless interface to receive serially transmitted messages from user input devices, such as the depicted keyboard 920. The interface controller 995b may employ any of a variety of cabling-based or wireless timings and/or protocols to access other computing devices through the depicted network 999 (perhaps a network made up of one or more links, smaller networks, or perhaps the Internet). The interface 995c may employ any of a variety of electrically conductive cabling enabling the use of either serial or parallel transmission to convey data to the depicted printer 925. Other examples of devices that may be communicatively coupled through one or more interface controllers of the interface 990 include, without limitation, microphones, remote controls, stylus pens, card readers, finger print readers, virtual reality interaction gloves, graphical input tablets, joysticks, other keyboards, retina scanners, the touch input component of touch screens, trackballs, various sensors, a camera or camera array to monitor movement of persons to accept commands and/or data provided by those persons via gestures and/or facial expressions, laser printers, inkjet printers, mechanical robots, milling machines, etc.

Where a computing device is communicatively coupled to (or perhaps, actually incorporates) a display (e.g., the depicted example touch screen 980, corresponding to the display 780), such a computing device implementing the processing architecture 3000 may also include the display interface 985. Although more generalized types of interface may be employed in communicatively coupling to a display (whether of the touch screen variety, or not), the somewhat specialized additional processing often required in visually displaying various forms of content on a display, as well as the somewhat specialized nature of the cabling-based interfaces used, often makes the provision of a distinct display interface desirable. Wired and/or wireless communications technologies that may be employed by the display interface 985 in a communicative coupling of the touch screen 980 may make use of timings and/or protocols that conform to any of a variety of industry standards, including without limitation, any of a variety of analog video interfaces, Digital Video Interface (DVI), DisplayPort, etc.

Some systems may use Hadoop@, an open-source framework for storing and analyzing big data in a distributed computing environment. Some systems may use cloud computing, which can enable ubiquitous, convenient, on-demand network access to a shared pool of configurable computing resources (e.g., networks, servers, storage, applications and services) that can be rapidly provisioned and released with minimal management effort or service provider interaction. Some grid systems may be implemented as a multi-node Hadoop® cluster, as understood by a person of skill in the art. Apache™ Hadoop® is an open-source software framework for distributed computing. Some systems may use the SAS® LASR™ Analytic Server, which can deliver statistical modeling and machine learning capabilities in a highly interactive programming environment that enables multiple users to concurrently manage data, transform variables, perform exploratory analysis, build and compare models and score with virtually no regards on the size of the data stored in Hadoop®. Some systems may use SAS In-Memory Statistics for Hadoop® to read big data once and analyze it several times by persisting it in-memory for the entire session.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A computer-program product tangibly embodied in a non-transitory machine-readable storage medium, the computer-program product including instructions operable to cause a processor component to perform operations including:
identify requisite configuration information for execution of an application routine by the processor component, wherein the requisite configuration information enables the application routine to communicate with another computing device via a network during execution of the application routine;
generate an application programming interface (API) that specifies the requisite configuration information to a resource device via the network when the resource device accesses the API via the network;
operate a network interface that couples the processor component to the network to make the API accessible to the resource device via the network to enable the resource device to provide the requisite configuration information; and
relay the requisite configuration information following provision of the requisite configuration information by the resource device to the application routine for use during execution of the application routine and to a start component to trigger a start of execution of the application routine.

2. The computer-program product of claim 1, wherein:
the other computing device comprises the resource device; and
the requisite configuration information comprises at least one of a network address of the resource device, an account ID to gain access to a resource provided by the resource device, a password to gain access to a resource provided by the resource device, or contact information to use in transmitting an indication of an error encountered in using a resource provided by the resource device.

3. The computer-program product of claim 1, wherein the requisite configuration information comprises at least one of a network address at which the processor component makes a virtual machine (VM) in which the processor component executes the application routine accessible to the other computing device on the network, an account ID to be accepted by the VM to grant access to the VM from the network, or a password to be accepted by the VM to grant access to the VM from the network.

4. The computer-program product of claim 1, the processor component caused to perform operations including:
retrieve an indication of the requisite configuration information as a requisite for execution of the application routine from an application requisites data stored in a storage accessible to the processor component;
generate a catalog specifying multiple application routines and requisites for each application routine of the multiple application routines, wherein the multiple application routines comprises the application routine; and
relay the requisite configuration information to the application routine and the start component within the catalog.

5. The computer-program product of claim 4, the processor component caused to perform operations including generate a database of the multiple application routines and of the requisites for each application routine of the multiple application routines and generate the catalog from the database.

6. The computer-program product of claim 1, the processor component caused to perform operations including provide multiple virtual machines (VMs) within which the processor component executes multiple application routines, wherein the multiple application routines comprises the application routine.

7. The computer-program product of claim 6, the processor component caused to perform operations including:
identify other requisite configuration information for execution of an environment component to provide the multiple VMs, wherein the other requisite configuration information enables the environment component to cooperate with another resource device via the network during execution;
generate the API to specify the other requisite information;
monitor the interface for activity by the other resource device to provide the other requisite configuration information; and
relay the other requisite configuration information to the environment component to enable provision of the multiple VMs.

8. The computer-program product of claim 1, the processor component caused to perform operations including:
monitor the interface for activity by the resource device to provide an update to the requisite configuration information; and
relay the update to the application routine for use during further execution of the application routine and to the start component to trigger a restart of the application routine to enable the further execution.

9. The computer-program product of claim 1, wherein:
the API comprises at least one of hypertext transport protocol (HTTP) or secure HTTP (HTTPS) calls; and
generating the API comprises generating a webpage.

10. The computer-program product of claim 1, the processor component caused to perform operations including generate a webpage to enable entry of a security credential for use by the resource device in accessing the API to provide the requisite configuration information.

11. A computer-implemented method comprising:
identifying requisite configuration information for execution of an application routine by a processor component, wherein the requisite configuration information enables the application routine to communicate with another computing device via a network during execution of the application routine;
generating an application programming interface (API) that specifies the requisite configuration information to a resource device via the network when the resource device accesses the API via the network;
operating a network interface coupling the processor component to the network to make the API accessible to the resource device via the network to enable the resource device to provide the requisite configuration information;
and
relaying the requisite configuration information following provision of the requisite configuration information by the resource device to the application routine for use during execution of the application routine and to a start component to trigger a start of execution of the application routine.

12. The computer-implemented method of claim 11, wherein:
the other computing device comprises the resource device; and
the requisite configuration information comprises at least one of a network address of the resource device, an account ID to gain access to a resource provided by the resource device, a password to gain access to a resource provided by the resource device, or contact information to use in transmitting an indication of an error encountered in using a resource provided by the resource device.

13. The computer-implemented method of claim 11, wherein the requisite configuration information comprises at least one of a network address at which the processor component makes a virtual machine (VM) in which the processor component executes the application routine accessible to the other computing device on the network, an account ID to be accepted by the VM to grant access to the VM from the network, or a password to be accepted by the VM to grant access to the VM from the network.

14. The computer-implemented method of claim 11, comprising:
retrieving an indication of the requisite configuration information as a requisite for execution of the application routine from an application requisites data stored in a storage accessible to the processor component;
generating a catalog specifying multiple application routines and requisites for each application routine of the multiple application routines, wherein the multiple application routines comprises the application routine; and
relaying the requisite configuration information to the application routine and the start component within the catalog.

15. The computer-implemented method of claim 14, comprising:
generating a database of the multiple application routines and of the requisites for each application routine of the multiple application routines; and
generating the catalog from the database.

16. The computer-implemented method of claim 11, comprising providing multiple virtual machines (VMs) within which the processor component executes multiple application routines, wherein the multiple application routines comprises the application routine.

17. The computer-implemented method of claim 16, comprising:
identifying other requisite configuration information for execution of an environment component to provide the multiple virtual machines VMs, wherein the other requisite configuration information enables the environment component to cooperate with another resource device via the network during execution;
generating the API to specify the other requisite information;
monitoring the interface for activity by the other resource device to provide the other requisite configuration information; and
relaying the other requisite configuration information to the environment component to enable provision of the multiple VMs.

18. The computer-implemented method of claim 11, comprising:
monitoring the interface for activity by the resource device to provide an update to the requisite configuration information; and
relaying the update to the application routine for use during further execution of the application routine and to the start component to trigger a restart of the application routine to enable the further execution.

19. The computer-implemented method of claim 11, wherein:
the API comprises at least one of hypertext transport protocol (HTTP) or secure HTTP (HTTPS) calls; and
generating the API comprises generating a webpage.

20. The computer-implemented method of claim 11, comprising generating a webpage to enable entry of a security credential for use by the resource device in accessing the API to provide the requisite configuration information.

21. An apparatus comprising:
a processor component;
a network interface to couple the processor component to a network;
a discovery component for execution by the processor component to identify requisite configuration information for execution of an application routine, wherein the requisite configuration information enables the application routine to communicate with another computing device via the network during execution of the application routine;
an application program interface (API) generator for execution by the processor component to generate an API that specifies the requisite configuration information to the resource device via the network when the resource device accesses the API via the network, and to operate the network interface to make the API accessible to the resource device via the network to enable the resource device to provide the requisite configuration information; and
an API monitor to monitor the interface for activity by the resource device to provide the requisite configuration information, and to relay the requisite configuration information following provision of the requisite configuration information by the resource device to the application routine for use during execution of the application routine and to a start component to trigger a start of execution of the application routine.

22. The apparatus of claim 21, wherein:
the other computing device comprises the resource device; and
the requisite configuration information comprises at least one of a network address of the resource device, an account ID to gain access to a resource provided by the resource device, a password to gain access to a resource provided by the resource device, or contact information to use in transmitting an indication of an error encountered in using a resource provided by the resource device.

23. The apparatus of claim 21, wherein the requisite configuration information comprises at least one of a network address at which the processor component makes a virtual machine (VM) in which the processor component executes the application routine accessible to the other computing device on the network, an account ID to be accepted by the VM to grant access to the VM from the network, or a password to be accepted by the VM to grant access to the VM from the network.

24. The apparatus of claim 21, comprising:
a storage to store the application routine and an application requisites data that indicates the requisite configuration information as a requisite for execution of the application routine, wherein the discovery component retrieves the indication from the application requisites data; and
a control master to generate a catalog specifying multiple application routines and requisites for each application routine of the multiple application routines, and to relay the requisite configuration information to the application routine and the start component within the catalog, wherein the multiple application routines comprises the application routine.

25. The apparatus of claim 24, wherein the discovery component generates a database of the multiple application routines and of the requisites for each application routine of the multiple application routines to provide to the API generator.

26. The apparatus of claim 24, wherein the control master provides the catalog to at least one of application routine or the start component in response to a request for the catalog received from at least one of the application routine or the start component.

27. The apparatus of claim 21, comprising an environment component for execution by the processor component to provide multiple virtual machines (VMs) within which the processor component executes multiple application routines, wherein the multiple application routines comprises the application routine.

28. The apparatus of claim 27, wherein:
the discovery component identifies other requisite configuration information for execution of the environment component, wherein the other requisite configuration information enables the environment component to cooperate with another resource device via the network during execution;
the API specifies the other requisite information; and
the API monitor monitors the interface for activity by the other resource device to provide the other requisite configuration information and relays the other requisite configuration information to the environment component to enable provision of the multiple VMs.

29. The apparatus of claim 21, wherein the API monitor monitors the interface for activity by the resource device to provide an update to the requisite configuration information, and relays the update to the application routine for use during further execution of the application routine and to the start component to trigger a restart of the application routine to enable the further execution.

30. The apparatus of claim 21, wherein:
the API comprises at least one of hypertext transport protocol (HTTP) or secure HTTP (HTTPS) calls; and
generation of the API comprises generation of a webpage by the API generator.

31. The apparatus of claim 21, wherein the API generator generates a webpage to enable entry of a security credential for use by the resource device in accessing the API to provide the requisite configuration information.
